(19) United States
(12) Patent Application Publication
(10) Pub. No.: US 2024/0280361 A1
(43) Pub. Date: Aug. 22, 2024

(54) IMAGING DEVICE AND IMAGING METHOD

(71) Applicant: Integral Geometry Science Inc., Hyogo (JP)

(72) Inventors: Kenjiro KIMURA, Hyogo (JP); Noriaki KIMURA, Hyogo (JP); Fumitoshi KIMURA, Hyogo (JP)

(21) Appl. No.: 18/567,141

(22) PCT Filed: Jun. 9, 2022
(86) PCT No.: PCT/JP2022/023224

§ 371 Date: Dec. 5, 2023

(30) Foreign Application Priority Data
Jun. 11, 2021 (JP) 2021-098329

(51) Int. Cl. G01B 15/04

(52) U.S. Cl. CPC G01B 15/04

(57) ABSTRACT

An imaging device includes: a plurality of transmitters which are disposed on both sides of a region and transmit waves to the region; a plurality of receivers which are disposed on the both sides and receive the waves from the region; and an information processing circuit which derives an imaging function corresponding to a scattering field function related to scattering of the wave according to a correspondence between (i) measurement data obtained by the plurality of transmitters and the plurality of receivers and (ii) a composition of a plurality of functions related to multiple first-order scattering forming multiple scattering, and visualizes a three-dimensional structure of a scatterer included in an object in the region, using the imaging function.

### TECHNICAL FIELD

The present disclosure relates to an imaging device and the like that uses waves to visualize the three-dimensional structure of one or more scatterers included in an object in a region.

### BACKGROUND ART

Patent Literature (PTL) 1, PTL 2, PTL 3, PTL 4, and PTL 5 disclose techniques related to imaging devices and the like that use waves to visualize the three-dimensional structure of each scatterer included in an object in a region.

For example, with the technique disclosed in PTL 1, a beam transmitted from a microwave transmitter is incident on the object to be inspected, and the amplitude and phase of the scattered beams are detected by a microwave detector. The dielectric constant distribution is then calculated from the output signal of the microwave detector, and a section of the object is displayed.

### CITATION LIST

### [Patent Literature]

[PTL 1] Japanese Unexamined Patent Application Publication No. S62-66145

[PTL 2] International Patent Application Publication No. WO2014/125815

[PTL 3] International Patent Application Publication No. WO2015/136936

[PTL 4] International Patent Application Publication No. WO2021/020387

[PTL 5] International Patent Application Publication No. WO2021/053971

### SUMMARY OF INVENTION

### [Technical Problem]

However, it is not easy to visualize the three-dimensional structure of each scatterer included in an object in a region using waves. Specifically, when the state in the region is known, obtaining the data of the scattered waves radiated from the region relative to the waves incident on the region is called a forward problem, which is easy. On the other hand, when the scattered wave data is known, obtaining the state in the region is called an inverse problem, which is not easy.

In addition, for a single wave transmission, a plurality of scattering (reflections) may occur in the region. In other words, not only the first-order scattering corresponding to single scattering, but also the second-order scattering corresponding to two scattering, the third-order scattering corresponding to three scattering and the like may occur. Scattering more than once is also called multiple scattering. In some cases, data on scattered waves caused by multiple scattering may be obtained through measurement. An analytical method that considers only the first-order scattering but does not consider multiple scattering cannot accurately obtain the state in the region.

In view of the above, the present disclosure provides an imaging device and the like that is capable of visualizing, with high accuracy, the three-dimensional structure of one or more scatterers included in an object in a region, using waves.

### [Solution to Problem]

An imaging device according to one aspect of the present disclosure includes: a plurality of transmitters which are disposed on both sides of a region to be measured, and each of which transmits a wave to the region; a plurality of receivers which are disposed on the both sides, and each of which receives the wave; and an information processing circuit which derives an imaging function corresponding to a scattering field function related to scattering of the wave according to a correspondence between (i) measurement data obtained by the plurality of transmitters and the plurality of receivers and (ii) a composition of a plurality of functions related to multiple first-order scattering forming multiple scattering, and visualizes a three-dimensional structure of a scatterer included in an object in the region, using the imaging function.

General and specific aspects disclosed above may be implemented using a system, a device, a method, an integrated circuit, a computer program, or a computer-readable non-transitory recording medium such as a CD-ROM, or any combination of systems, devices, methods, integrated circuits, computer programs, or recording media.

### [Advantageous Effects of Invention]

According to the present disclosure, it is possible to visualize, with high accuracy, the three-dimensional structure of one or more scatterers included in an object in a region, using waves.

### BRIEF DESCRIPTION OF DRAWINGS

FIG. 1 is a conceptual diagram illustrating an example of multiple scattering orders according to an embodiment.

FIG. 2 is a diagram illustrating four types of scattering states corresponding to four types of fundamental solutions of a scattering field equation.

FIG. 3 is a conceptual diagram relating to a definition of the Green's function.

FIG. 4 is a conceptual diagram illustrating an application example of fundamental solutions of a scattering field.

FIG. 5 illustrates wave propagation paths.

FIG. 6 is a conceptual diagram illustrating an application example of fundamental solutions of a scattering field related to second-order scattering.

FIG. 7 illustrates four types of scattering models related to third-order scattering.

FIG. 8 illustrates definitions of four types of measurement data.

FIG. 9 is a block diagram illustrating a basic configuration of an imaging device according to the embodiment.

FIG. 10 is a conceptual diagram illustrating an example of a relation between a plurality of transmitters, a plurality of receivers, and a region.

FIG. 11 is a conceptual diagram illustrating a variation of the relation between the plurality of transmitters, the plurality of receivers, and the region.

FIG. 12 is a flowchart illustrating a basic operation of the imaging device according to the embodiment.

FIG. 13 is a block diagram illustrating a specific configuration of the imaging device according to the embodiment.

### DESCRIPTION OF EMBODIMENT

An imaging device according to one aspect of the present disclosure includes: a plurality of transmitters which are disposed on both sides of a region to be measured, and each of which transmits a wave to the region; a plurality of receivers which are disposed on the both sides, and each of which receives the wave; and an information processing circuit which derives an imaging function corresponding to a scattering field function related to scattering of the wave according to a correspondence between (i) measurement data obtained by the plurality of transmitters and the plurality of receivers and (ii) a composition of a plurality of functions related to multiple first-order scattering forming multiple scattering, and visualizes a three-dimensional structure of a scatterer included in an object in the region, using the imaging function.

This allows the imaging device to apply the correspondence between the measurement data and the composition of a plurality of functions related to multiple first-order scattering to derive an imaging function for visualizing the three-dimensional structure of each scatterer included in an object in a region. Multiple scattering is assumed to be a combination of multiple first-order scattering. Hence, the imaging device is capable of analytically solving the inverse problem of scattering, including multiple scattering, according to this correspondence. Accordingly, the imaging device is capable of visualizing, with high accuracy, the three-dimensional structure of each scatterer included in an object in a region.

For example, the information processing circuit derives the imaging function corresponding to the scattering field function by solving an equation of the scattering field function based on the measurement data. The scattering field function is expressed by

$$ϕ ( x , {y}_{1} , {y}_{2} , {z}_{1} , {z}_{2} , k ) = \int {\int }_{D} \frac{{e}^{ik {ρ}_{1}}}{{ρ}_{1}} \frac{{e}^{ik {ρ}_{2}}}{{ρ}_{2}} ε ( ξ , η , ζ ) d ξ η d ζ \qquad [ Math . 1 ]$$

where (x, y₁, z₁) denotes a transmission position of the wave, (x, y₂, x₂) denotes a reception position of the wave, k denotes a wave number of the wave, D denotes the region, (ξ, η, ζ) corresponds to a reflection position of the wave, ϵ corresponds to an unknown reflectance at the reflection position, ρ₁ denotes a distance from the transmission position to the reflection position, and ρ₂ denotes a distance from the reflection position to the reception position. The equation is expressed by

$$[ \frac{1}{4} {Δ}_{5}^{2} - \frac{1}{{c}^{2}} {\partial }_{t}^{2} {\partial }_{x}^{2} - ( {\partial }_{{y}_{1}}^{2} + {\partial }_{{z}_{1}}^{2} ) ( {\partial }_{{y}_{2}}^{2} + {\partial }_{{z}_{2}}^{2} ) ] ϕ = 0 \qquad [ Math . 2 ]$$

where Δ₅ denotes a Laplace operator related to x, y₁, y₂, z₁, and z₂, c denotes a propagation velocity of the wave, and t denotes a time taken from transmission of the wave to reception of the wave.

This allows the imaging device to visualize, with high accuracy, the three-dimensional structure of each scatterer included in an object in a region, according to the scattering field function associated with the scattering phenomenon and the equation satisfied by the scattering field function.

Moreover, for example, the information processing circuit derives an analytical solution of the equation based on the measurement data, and derives the imaging function based on the analytical solution, and the analytical solution is expressed by

$$ϕ ( x , {y}_{1} , {y}_{2} , {z}_{1} , {z}_{2} , k ) = \frac{1}{{( 2 π )}^{3}} {\int }_{∞}^{∞} {\int }_{- ∞}^{∞} {\int }_{∞}^{∞} {e}^{- i ( {k}_{x} x + {k}_{y 1} {y}_{1} + {k}_{y 2} {y}_{2} )} a ( {k}_{x} , {k}_{{y}_{1}} , {k}_{{y}_{2}} , k ) {e}^{{is}_{1} ( {k}_{x} , {k}_{y 1} , {k}_{y 2} ) {z}_{1}} {e}^{{is}_{2} ( {k}_{x} , {k}_{y 1} , {k}_{y 2} ) {z}_{2}} {dk}_{x} {dk}_{{y}_{1}} {dk}_{{y}_{2}} \qquad [ Math . 3 ]$$

where kₓ, k_{y1}, and k_{y2} denote wave numbers related to x, y₁, and y₂ of the scattering field function, a(kₓ, k_{y1}, k_{y2}, k) denotes a function based on kₓ, k_{y1}, k_{y2}, and k, s₁(kₓ, k_{y1}, k_{y2}) denotes a function based on kₓ, k_{y1}, and k_{y2}, and s₂(kₓ, k_{y1}, k_{y2}) denotes a function based on kₓ, k_{y1}, and k_{y2}.

This allows the imaging device to visualize, with high accuracy, the three-dimensional structure of each scatterer included in an object in a region according to the analytical solution of the equation satisfied by the scattering field function associated with the scattering phenomenon.

Moreover, for example, the imaging function is expressed by

$$ρ ( x , y , z ) \to {Lim}_{t \to 0} [ \frac{1}{2 π} {\int }_{- ∞}^{∞} ϕ ( x , y , y , z , z , k ) {e}^{- ickt} dk ] \qquad [ Math . 4 ]$$

where (x, y, z) denotes a position of an imaging target.

This allows the imaging device to visualize, with high accuracy, the three-dimensional structure of each scatterer included in an object in a region according to the imaging function appropriately associated with the scattering field function.

Moreover, for example, the multiple scattering is expressed using four functions of a spectral space corresponding to four fundamental solutions of an equation of the scattering field function, a relation between the measurement data and the four functions is expressed by a non-linear integral equation, and the information processing circuit: derives the four functions from the measurement data according to the non-linear integral equation; and derives the imaging function corresponding to the scattering field function, using the four functions.

This allows the imaging device to visualize, with high accuracy, the three-dimensional structure of each scatterer included in an object in a region according to a relational expression that expresses multiple scattering.

Moreover, for example, the measurement data is expressed by

$${{Φ}_{ij}}_{i , j = 1 , 2} \qquad [ Math . 5 ]$$

where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions, the information processing circuit uses

$${{Φ}_{ij}}_{i , j = 1 , 2} = {{a}_{{m}_{1}}}_{{m}_{1} = 1 , 2 , 3 , 4} + \frac{1}{{( 2 π )}^{1}} \int {f}_{2} {[ {a}_{{m}_{1}} {a}_{{m}_{2}} ]}_{{m}_{1} , {m}_{2} = 1 , 2 , 3 , 4} d {𝕜}_{{f}_{2}} + \frac{1}{{( 2 π )}^{2}} \int {f}_{3} {[ {a}_{{m}_{1}} {a}_{{m}_{2}} {a}_{{m}_{3}} ]}_{{m}_{1} , {m}_{2} , {m}_{3} = 1 , 2 , 3 , 4} d {𝕜}_{{f}_{3}} + … + \frac{1}{{( 2 π )}^{L - 1}} \int {f}_{L} {[ {a}_{{m}_{1}} {a}_{{m}_{2}} {a}_{{m}_{3}} … {a}_{{m}_{L}} ]}_{{m}_{1} , {m}_{2} , {m}_{3} , … , {m}_{L} = 1 , 2 , 3 , 4} d {𝕜}_{{f}_{L}} \qquad [ Math . 6 ]$$

$$to derive$$

$${{a}_{{m}_{1}}}_{{m}_{1} = 1 , 2 , 3 , 4} \qquad [ Math . 7 ]$$

from which an effect of multiple scattering has been removed, where a₁, a₂, a₃, and a₄ expressed by aₘ₁, aₘ₂, aₘ₃, . . . , a_{mL} correspond to a(kₓ, k_{y1}, k_{y2}, k) in the analytical solution related to the four scattering states, f₂, f₃, . . . , f_{L} denote products of 2, 3, . . . , L variables in square brackets corresponding to 2, 3, . . . , L scattering applied from transmission of the wave to reception of the wave, respectively,

$${𝕜}_{{f}_{2}} , {𝕜}_{{f}_{3}} , … , {𝕜}_{{f}_{L}} \qquad [ Math . 8 ]$$

denote wave number vectors related to coordinate variables included in 2, 3, . . . , L variables in square brackets of f₂, f₃, . . . , f_{L}, and the information processing circuit uses, as the scattering field function,

$${ϕ}_{{m}_{1}} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{{m}_{1}} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 9 ]$$

$${m}_{1} = 1 , 2 , 3 , 4$$

to derive, as the imaging function,

$$ρ ( x , y , z ) = {Lim}_{t \to 0} [ \frac{1}{2 π} {{\int }^{∞}}_{- ∞} {ϕ}_{{m}_{1}} ( x , y , y , z , z , k ) {e}^{- ickt} dk ] \qquad [ Math . 10 ]$$

This allows the imaging device to visualize, with high accuracy, the three-dimensional structure of each scatterer included in an object in a region according to the equation based on the multiple scattering theory.

Moreover, for example, the measurement data is expressed by

$${{Φ}_{ij}}_{i , j = 1 , 2} \qquad [ Math . 11 ]$$

where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions, the information processing circuit uses

$$\begin{matrix}{{a}_{m}}_{m = 1 , 2 , 3 , 4} = {{Φ}_{ij}}_{ij = 1 , 2} \\ - \frac{1}{{( 2 π )}^{1}} \int {g}_{2} {[ {Φ}_{{m}_{1} {n}_{1}} {Φ}_{{m}_{2} {n}_{2}} ]}_{{{m}_{1} , {n}_{1} = 1 , 2}_{{m}_{2} , {n}_{2} = 1 , 2}} d {𝕜}_{{g}_{2}} \\ - \frac{1}{{( 2 π )}^{2}} \int {g}_{3} {[ {Φ}_{{m}_{1} {n}_{1}} {Φ}_{{m}_{2} {n}_{2}} {Φ}_{{m}_{3} {n}_{3}} ]}_{{{m}_{1} , {n}_{1} = 1 , 2}_{{{m}_{2} , {n}_{2} = 1 , 2}_{{m}_{3} , {n}_{3} = 1 , 2}}} d {𝕜}_{{g}_{3}} \\ - … \\ - \frac{1}{{( 2 π )}^{L - 1}} \int {g}_{L} {[ {Φ}_{{m}_{1} {n}_{1}} {Φ}_{{m}_{2} {n}_{2}} {Φ}_{{m}_{3} {n}_{3}} … {Φ}_{{m}_{L} {n}_{L}} ]}_{{{m}_{1} , {n}_{1} = 1 , 2}_{{{m}_{2} , {n}_{2} = 1 , 2}_{{{m}_{3} , {n}_{3} = 1 , 2}_{{…}_{{m}_{L} , {n}_{L} = 1 , 2}}}}} d {𝕜}_{{g}_{L}}\end{matrix} \qquad [ Math . 12 ]$$

$$to derive$$

$${{a}_{m}}_{m = 1 , 2 , 3 , 4} \qquad [ Math . 13 ]$$

from which an effect of multiple scattering has been removed, where a₁, a₂, a₃, and a₄ expressed by aₘ correspond to a(kₓ, k_{y1}, k_{y2}, k) in the analytical solution related to the four scattering states, Φ₁₁, Φ₁₂, Φ₂₁, and Φ₂₂ expressed by Φₘ₁ₙ₁, Φₘ₂ₙ₂, Φₘ₃ₙ₃, . . . , Φ_{mLnL} correspond to the measurement data related to the four scattering states, g₂, g₃, . . . , g_{L} denote products of 2, 3, . . . , L variables in square brackets corresponding to 2, 3, . . . , L scattering applied from transmission of the wave to reception of the wave, respectively,

$${𝕜}_{{g}_{2}} , {𝕜}_{{g}_{3}} , … , {𝕜}_{{g}_{L}} \qquad [ Math . 14 ]$$

denote wave number vectors related to coordinate variables included in 2, 3, . . . , L variables in square brackets of g₂, g₃, . . . , g_{L}, and the information processing circuit uses, as the scattering field function,

$${ϕ}_{m} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{m} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 15 ]$$

$$m = 1 , 2 , 3 , 4$$

to derive, as the imaging function,

$$ρ ( x , y , z ) = {Lim}_{t \to 0} [ \frac{1}{2 π} {{\int }^{∞}}_{- ∞} {ϕ}_{m} ( x , y , y , z , z , k ) {e}^{- ickt} dk ] . \qquad [ Math . 16 ]$$

This allows the imaging device to visualize, with high accuracy, the three-dimensional structure of each scatterer included in an object in a region according to the equation in which the measurement data is properly associated based on the multiple scattering theory.

Moreover, for example, the measurement data is expressed by

$${{Φ}_{ij}}_{i , j = 1 , 2} \qquad [ Math . 17 ]$$

where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions, the information processing circuit uses

$${Φ}_{11} ( {k}_{x} , {k}_{{y}_{1}} , {k}_{{y}_{2}} , k ) = {a}_{1} ( {k}_{x} , {k}_{{y}_{1}} , {k}_{{y}_{2}} , k ) \qquad [ Math . 18 ]$$

$$+ \frac{1}{( 2 π )} \int \int \int {a}_{1} ( {k}_{{x}_{a}} , {k}_{{y}_{1}} , {k}_{η} , k ) {a}_{4} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {{dk}_{x}}_{a} {{dk}_{x}}_{b} {dk}_{η}$$

$$+ \frac{1}{{( 2 π )}^{2}} \int \int \int \int \int {a}_{1} ( {k}_{xa} , {k}_{{y}_{1}} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$+ \frac{1}{{( 2 π )}^{2}} \int \int \int \int \int {a}_{3} ( {k}_{xa} , {k}_{{y}_{1}} , - {k}_{{η}_{2}} , k ) {a}_{1} ( {k}_{xb} , {k}_{{η}_{2}} , - {k}_{{η}_{3}} , k ) {a}_{4} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$+ \frac{1}{{( 2 π )}^{2}} \int \int \int \int \int {a}_{1} ( {k}_{xa} , {k}_{{y}_{1}} , - {k}_{{η}_{2}} , k ) {a}_{4} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$+ \frac{1}{{( 2 π )}^{2}} \int \int \int \int \int {a}_{3} ( {k}_{xa} , {k}_{{y}_{1}} , - {k}_{{η}_{2}} , k ) {a}_{3} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$+ O ( {a}^{4} )$$

to derive a₁ from which an effect of multiple scattering has been removed, where δ denotes a delta function, kₓₐ, k_{xb}, and k_{xc} are variables corresponding to kₓ, k_{η} and k_{η2} are variables corresponding to k_{y1}, k_{η3} is a variable corresponding to k_{y2}, and O(a⁴) is a term corresponding to a fourth or higher order scattering, and the information processing circuit uses, as the scattering field function,

$${ϕ}_{1} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} , {dk}_{{y}_{1}} , {dk}_{{y}_{2}} \qquad [ Math . 19 ]$$

to derive, as the imaging function,

$$ρ ( x , y , z ) = {Lim}_{t \to 0} [ \frac{1}{2 π} {{\int }^{∞}}_{- ∞} {ϕ}_{1} ( x , y , y , z , z , k ) {e}^{- ickt} dk ] \qquad [ Math . 20 ]$$

This allows the imaging device to visualize, with high accuracy, the three-dimensional structure of each scatterer included in an object in a region according to the equation in which the scattering phenomenon is concretely expressed based on the multiple scattering theory.

Moreover, for example, the measurement data is expressed by

$${{Φ}_{ij}}_{i , j = 1 , 2} \qquad [ Math . 21 ]$$

where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions, the information processing circuit uses

$${a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) \qquad [ Math . 22 ]$$

$$- \frac{1}{( 2 π )} \int \int \int {Φ}_{11} ( {k}_{{x}_{a}} , {k}_{{y}_{1}} {k}_{η} , k ) {Φ}_{21} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {{dk}_{x}}_{a} {{dk}_{x}}_{b} {dk}_{η}$$

$$- \frac{1}{{( 2 π )}^{2}} \int \int \int \int \int {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$- \frac{1}{{( 2 π )}^{2}} \int \int \int \int \int {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$- \frac{1}{{( 2 π )}^{2}} \int \int \int \int \int {Φ}_{11} ( {k}_{xa} , {k}_{{y}_{1}} , - {k}_{{η}_{2}} , k ) {Φ}_{21} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

$$- \frac{1}{{( 2 π )}^{2}} \int \int \int \int \int {Φ}_{12} ( {k}_{xa} , {k}_{{y}_{1}} , - {k}_{{η}_{2}} , k ) {Φ}_{12} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} + - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}}$$

to derive a₁ from which an effect of multiple scattering has been removed, where δ denotes a delta function, kₓₐ, k_{xb}, and k_{xc} are variables corresponding to kₓ, k_{η} and k_{η2} are variables corresponding to k_{y1}, k_{η3} is a variable corresponding to k_{y2}, and the information processing circuit uses, as the scattering field function,

$${ϕ}_{1} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} , {dk}_{{y}_{1}} , {dk}_{{y}_{2}} \qquad [ Math . 23 ]$$

to derive, as the imaging function,

$$ρ ( x , y , z ) = \text{?} [ \frac{1}{2 π} {{\int }^{∞}}_{- ∞} {ϕ}_{1} ( x , y , y , z , z , k ) {e}^{ickt} dk ] \qquad [ Math . 24 ]$$

$$\text{?} \text{indicates text missing or illegible when filed}$$

This allows the imaging device to visualize, with high accuracy, the three-dimensional structure of each scatterer included in an object in a region according to the equation in which the scattering phenomenon is concretely expressed based on the multiple scattering theory and the measurement data is properly associated.

Moreover, for example, the measurement data is expressed by

$${{Φ}_{ij}}_{i , j = 1 , 2} \qquad [ Math . 25 ]$$

where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions, the information processing circuit uses

$${a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{( 2 π )} \text{} \int \int \int {Φ}_{11} ( {k}_{{x}_{a}} , {k}_{{y}_{1}} , {k}_{η} , k ) \text{} {Φ}_{21} ( {k}_{{x}_{b}} , - {k}_{η} , \text{} {k}_{{y}_{2}} , \text{} k ) \text{} δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int \{ {Φ}_{11} ( {k}_{xa} , {k}_{{y}_{1}} , \text{} - {k}_{{η}_{2}} , \text{} k ) \text{} {Φ}_{22} ( \text{} {k}_{xb} , \text{} {k}_{{η}_{2}} , \text{} - {k}_{{η}_{3}} , \text{} k ) \text{} {Φ}_{11} ( {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{11} ( {k}_{xa} , {k}_{{y}_{1}} , - {k}_{{η}_{2}} , k ) {Φ}_{21} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{12} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \} \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xc} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} \qquad [ Math . 26 ]$$

to derive a₁ from which an effect of multiple scattering has been removed, where δ denotes a delta function, kₓₐ, k_{xb}, and k_{xc} are variables corresponding to kₓ, k_{η} and k_{η2} are variables corresponding to k_{y1}, K_{η3} is a variable corresponding to k_{y2}, and the information processing circuit uses, as the scattering field function,

$$[ Math . 27 ]$$

$${ϕ}_{1} ( x , {y}_{1} , {y}_{2} , {z}_{1} , {z}_{2} , k ) = \frac{1}{{( 2 π )}^{3}} \text{?} {a}_{1} ( {k}_{x} , {k}_{{y}_{1}} , {k}_{{y}_{2}} , k ) \cdot \text{?} {dk}_{x} {dk}_{{y}_{1}} {dk}_{{y}_{2}}$$

$$\text{?} \text{indicates text missing or illegible when filed}$$

to derive, as the imaging function,

$$ρ ( x , y , z ) = {Lim}_{t \to 0} [ \frac{1}{2 π} {{\int }^{∞}}_{- ∞} {ϕ}_{1} ( x , y , y , z , z , k ) {e}^{- ickt} dk ] \qquad [ Math . 28 ]$$

This allows the imaging device to visualize, with high accuracy, the three-dimensional structure of each scatterer included in an object in a region according to the equation rearranged based on the multiple scattering theory.

Moreover, for example, an imaging method according to one aspect of the present disclosure includes: transmitting, by each of a plurality of transmitters disposed on both sides of the region, a wave to a region to be measured; receiving, by each of a plurality of receivers disposed on the both sides, the wave from the region; and deriving an imaging function corresponding to a scattering field function related to scattering of the wave according to a correspondence between (i) measurement data obtained by the plurality of transmitters and the plurality of receivers and a composition of a plurality of functions related to multiple first-order scattering forming multiple scattering, and visualizing a three-dimensional structure of a scatterer included in an object in the region, using the imaging function.

This allows the correspondence between the measurement data and the composition of a plurality of functions related to multiple first-order scattering to be applied to derive an imaging function for visualizing the three-dimensional structure of each scatterer included in an object in a region. Multiple scattering is assumed to be a combination of multiple first-order scattering. Accordingly, it is possible to analytically solve the inverse problem of scattering, including multiple scattering, according to this correspondence. As a result, it is possible to visualize, with high accuracy, the three-dimensional structure of each scatterer included in an object in a region, using waves.

Hereinafter, an embodiment will be described with reference to the drawings. It should be noted that the embodiment described below shows a general or specific example. The numerical values, shapes, materials, structural elements, the arrangement and connection of the structural elements, steps, the order of steps, etc., illustrated in the following embodiment are mere examples, and therefore do not limit the claims.

In the following description, in particular, the techniques and the like disclosed in PTL 2, PTL 3, PTL 4, and PTL 5 can be referred to as known techniques. Moreover, in the following description, radio waves such as microwaves are mainly assumed to be waves, but the waves are not limited to radio waves such as microwaves. In addition, imaging based on scattering can be referred to as scattering tomography. Accordingly, the imaging device and the imaging method in the following description can also be referred to as a scattering tomography device and a scattering tomography method, respectively.

### EMBODIMENT

An imaging device according to the present embodiment uses waves to visualize the three-dimensional structure of one or more scatterers included in an object in a region. Hereinafter, the imaging device according to the present embodiment will be described in detail including the underlying techniques and theories.

### <I Outline>

Scattering field theory has been constructed to image the inside of an object using waves such as microwaves. The scattering field theory is not only theoretically novel, but also useful in practice.

Since it is possible to instantly calculate an accurate three-dimensional reconstructed image from measured (measurement) data, it is expected to be applied to the field of diagnostic imaging, and the like. In the present disclosure, the scattering field theory is advanced to solve the difficult inverse scattering problem of multiple scattering (multiple reflections), and an imaging device and an imaging method using the advanced scattering field theory are provided.

For example, in the inverse scattering reconstruction theory where the measurement surface on which a transmission position and a reception position are arranged is a curved surface, function o as shown in (1-1) below is defined.

$$\begin{matrix}[ Math . 29 ] & \\ ϕ ( x , {y}_{1} , {y}_{2} , {z}_{1} , {z}_{2} , k ) = \int {\int }_{D} \frac{{e}^{ik {ρ}_{1}}}{{ρ}_{1}} \frac{{e}^{ik {ρ}_{2}}}{{ρ}_{2}} ε ( ξ , η , ζ ) d ξ d η d ζ & ( 1 - 1 )\end{matrix}$$

Here, (x, y₁, z₁) denotes the coordinates of the wave radiation position, and (x, y₂, z₂) denotes the coordinates of the wave reception position, Radiation may also be referred to as transmission. Moreover, k denotes the wave number of wave, and D denotes the region to be measured. ϵ(ξ, η, ζ) denotes the function of the dielectric constant at the position (ξ, η, ζ), and corresponds to the wave reflectance at the position (ξ, η, ζ). (ξ, η, ζ) corresponds to the reflection position of the wave. ρ₁ denotes the distance from the transmission position to the reflection position, and ρ₂ denotes the distance from the reflection position to the reception position. Note that ϵ(ξ, η, ζ) is unknown.

The phenomenon, in which waves are scattered at the point where the value of the dielectric constant function ⊖(ξ, η, ζ) is large, is considered as a function with respect to the wave radiation position and the wave reception position. By defining the radiation position and the reception position throughout the region, the above φ is used as a scattering field function that indicates the scattering field. The scattering field function satisfies the partial differential equation as shown in (1-2) below.

$$\begin{matrix}[ Math . 30 ] & \\ [ \frac{1}{4} {{Δ}_{5}}^{2} - \frac{1}{{c}^{2}} \text{?} - ( \text{?} + \text{?} ) ( \text{?} + \text{?} ) ] ϕ = 0 & ( 1 - 2 )\end{matrix}$$

$$\text{?} \text{indicates text missing or illegible when filed}$$

Here, Δ₅ denotes the five-dimensional Laplace operator related to x, y₁, y₂, z₁ and z₂, a denotes the partial differential of the variable indicated by the suffix, c denotes the wave propagation velocity, and t denotes time. The general solution of the differential equation in (1-2) is expressed as shown in (1-3) below.

$$\begin{matrix}[ Math . 31 ] & \\ & ( 1 - 3 )\end{matrix}$$

$$ϕ ( x , {y}_{1} , {y}_{2} , {z}_{1} , {z}_{2} , k ) = \frac{1}{{( 2 π )}^{3}} \text{?} a ( {k}_{x} , {k}_{{y}_{1}} , {k}_{{y}_{2}} , k ) \text{?} {dk}_{x} {dk}_{{y}_{1}} {dk}_{{y}_{2}}$$

$$\text{?} \text{indicates text missing or illegible when filed}$$

Here, kₓ, k_{y1}, and k_{y2} denote wave numbers related to x, y₁, and y₂ of the scattering field function. Since the solution of a single fourth-order partial differential equation is completely determined by the measurement value (radar reflection data) at the region boundary, a(kₓ, k_{y1}, k_{y2}, k) that is the kernel function of the general solution is also found by Fourier transform. Then, by applying the limit values of y₂->y₁ and t ->0 to φ, an imaging function p is obtained. For example, the imaging function ρ is expressed as shown in (1-4) below.

$$\begin{matrix}[ Math . 32 ] & \\ ρ ( x , y , z ) = {Lim}_{t \to 0} [ \frac{1}{2 π} {{\int }^{∞}}_{- ∞} ϕ ( x , y , y , z , z , k ) {e}^{- ickt} dk ] & ( 1 - 4 )\end{matrix}$$

In the above process, the scattering field function (x, y₁, y₂, z₁, z₂, k) is directly connected to the measurement value (radar reflection data) at the boundary of the region based on the assumption that there is no multiple scattering. For example, the shape of the boundary surface is defined by the curve z=f(y) on the z-y plane. The data obtained by Fourier transforming the radar reflection data measured at the boundary surface with respect to (x, t) is expressed by Φ(kₓ, y₁, y_{J}, k). Under the assumption that there is no multiple scattering, (1-5) shown below is assumed to hold true.

$$\begin{matrix}[ Math . 33 ] & \\ Φ ( {k}_{x} , \text{?} , \text{?} , k ) = \frac{1}{{( 2 π )}^{2}} \text{?} ( {k}_{x} , {k}_{{y}_{1}} , {k}_{{y}_{2}} , k ) \cdot \text{?} {dk}_{{y}_{1}} {dk}_{{y}_{2}} & ( 1 - 5 )\end{matrix}$$

$$\text{?} \text{indicates text missing or illegible when filed}$$

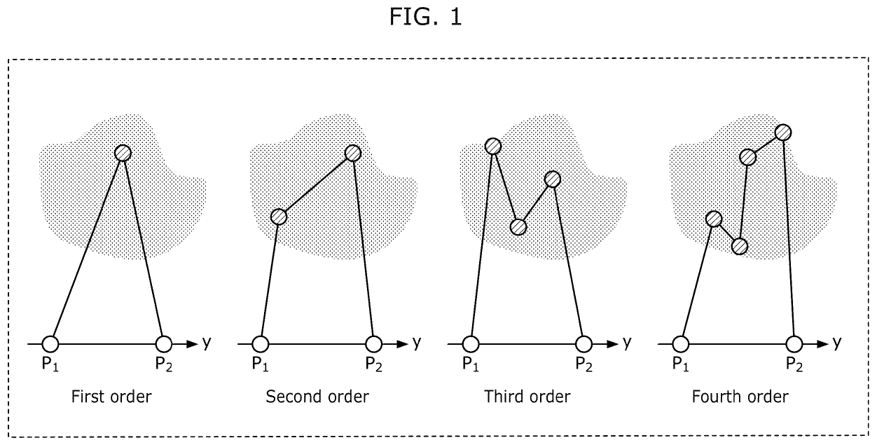

However, when multiple scattering is not allowed to be ignored, second-order, third-order, and fourth-order scattering may be present, as illustrated in FIG. 1.

FIG. 1 is a conceptual diagram illustrating an example of multiple scattering (multiple reflections) orders according to the embodiment. In FIG. 1, P₁ denotes the transmission position and P₂ denotes the reception position. A signal is transmitted from P₁ and received at P₂ through a number of reflections corresponding to the order in the region. A plurality of reflections are referred to as multiple reflections or multiple scattering.

The present disclosure describes a solving method for solving the inverse problem of scattering including multiple scattering as described above, and an imaging device and an imaging method using the solving method.

In order to perform the inverse analysis of multiple scattering, radar reflection data across the boundaries of the region is used. Multiple scattering of second or higher order is expressed by a combination (composition) of four types of fundamental solutions, E₁, E₂, E₃, and E₄ of the partial differential equation of the scattering field.

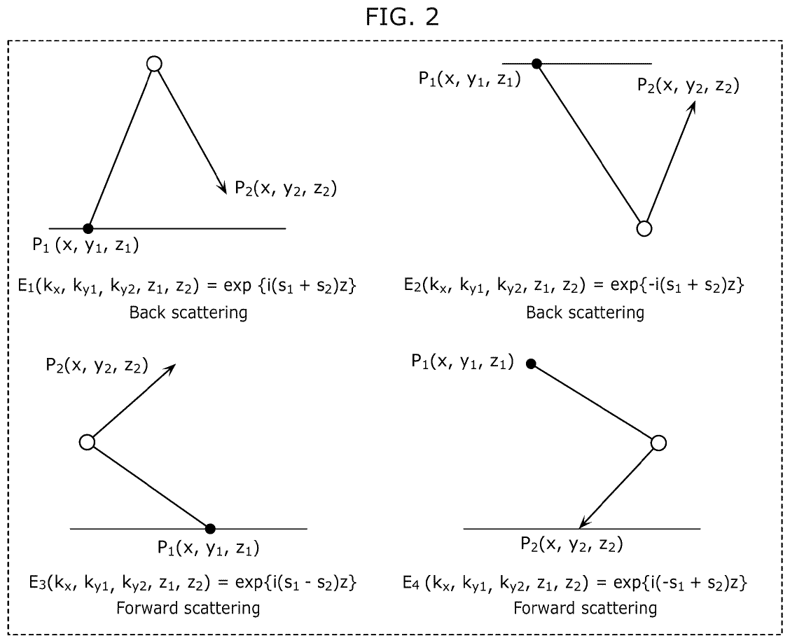

FIG. 2 illustrates four types of scattering states corresponding to four types of fundamental solutions of a scattering field equation. The scattering state can also be referred to as a scattering model.

Multiple scattering is expressed by the composition of these four fundamental solutions (E₁, E₂, E₃, E₄). The functions of the spectral space that are a₁, a₂, a₃, and a₄ are introduced corresponding to E₁, E₂, E₃ and E₄. In order to determine these from the measurement data, two back scattering and one forward scattering are measured.

Inverse scattering analysis of multiple scattering in the three-dimensional region is a difficult problem. However, the present disclosure provides the solution of the inverse scattering problem using scattering field theory.

### <II Scattering Field Theory>

### <II-1 Simple Propagation Function>

The Helmholtz equation of wave propagation is expressed by (2-1) below.

$$\begin{matrix}[ Math . 34 ] & \\ ( {Δ}_{3} + {k}^{2} ) ϕ ( x - ξ , y - η , z - ζ , k ) = 0 & ( 2 - 1 )\end{matrix}$$

Here, φ is an unknown function that denotes the vibration displacement at the position (x, y, z), Δ₃ denotes the three-dimensional Laplacian operator, k denotes the wave number, and (ξ, η, ζ) denotes the position of the wave source,

The equation obtained by Fourier transforming φ with respect to (x, y, t) is expressed as shown in (2-2) below.

$$\begin{matrix}[ Math . 35 ] & \\ & ( 2 - 2 )\end{matrix}$$

$$\tilde{ϕ} ( {k}_{x} , {k}_{y} , z - ζ , k ) = {{\int }^{∞}}_{- ∞} {e}^{ickt} dt {{\int }^{∞}}_{- ∞} {e}^{{ik}_{y} ( y - η )} dy {{\int }^{∞}}_{- ∞} {e}^{{ik}_{x} ( x - ξ )} ϕ ( x - ξ , y - η , z - ζ , t ) dx$$

Here, kₓ denotes the wave number related to x, and K_{y} denotes the wave number related to y. Equation (2-1) is transformed into, for example, as shown in (2-3) and (2-4) below.

$$\begin{matrix}[ Math . 36 ] & \\ \{ \text{?} + ( {k}^{2} - \text{?} - \text{?} ) \} \tilde{ϕ} ( {k}_{x} , {k}_{y} , z , k ) = 0 & ( 2 - 3 )\end{matrix}$$

$$\begin{matrix}[ Math . 37 ] & \\ ϕ ( x - ξ , y - η , z - ζ , k ) = \frac{1}{{( 2 π )}^{2}} \int \int \text{?} a ( {k}_{x} , {k}_{y} , k ) \text{?} {dk}_{x} {dk}_{y} & ( 2 - 4 )\end{matrix}$$

$$\text{?} \text{indicates text missing or illegible when filed}$$

Here, ∂_{z}² denotes a second partial differential with respect to z, and a(kₓ, k_{y}, k) is a function related to (kₓ, k_{y}, k).

### <II-2 Fundamental Solution of Scattering Field>

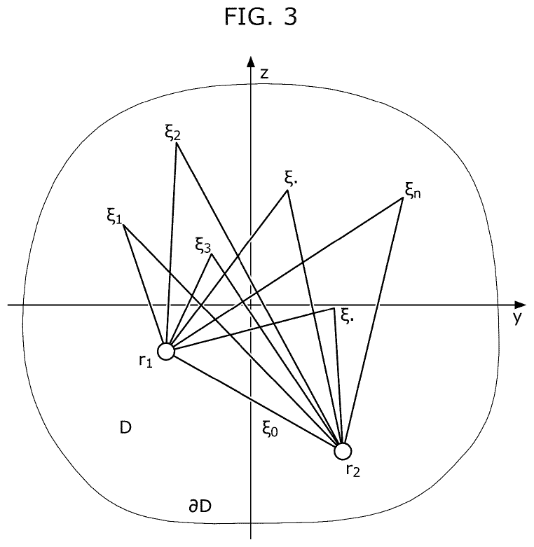

FIG. 3 is a conceptual diagram relating to the definition of the Green's function. Hereinafter, unless otherwise specified, the transmission position and the reception position have the same x-coordinate. When the transmission position and the reception position are r₁=(x, y₁, z₁) and r₂=(x, y₂, z₂) respectively, the Green's function is defined as shown in (2-5) below.

$$\begin{matrix}[ Math . 38 ] & \\ G ( {r}_{1} , {r}_{2} , ω ) = \int \int {\int }_{D} φ ( {r}_{1} \to ξ \to {r}_{2} , ω ) d ξ & ( 2 - 5 )\end{matrix}$$

This integral kernel function denotes the signal strength of the wave that exits r₁, is reflected at point ξ, and returns to point r₂. ω is the angular frequency. This Green's function is materialized using a new function name as shown in (2-6) below. Here, ϵ is a function of dielectric constant.

$$\begin{matrix}[ Math . 39 ] & \\ ϕ ( x , {y}_{1} , {y}_{2} , {z}_{1} , {z}_{2} ) = \int {\int }_{D} \frac{{e}^{ik {ρ}_{1}}}{{ρ}_{1}} \frac{{e}^{ik {ρ}_{2}}}{{ρ}_{2}} ε ( ξ , η , ζ ) d ξ d η d ζ & ( 2 - 6 )\end{matrix}$$

$${ρ}_{1} = \sqrt{{( x - ξ )}^{2} + {( {y}_{1} - η )}^{2} + {( {z}_{1} - ζ )}^{2}}$$

$${ρ}_{2} = \sqrt{{( x - ξ )}^{2} + {( {y}_{2} - η )}^{2} + {( {z}_{2} - ζ )}^{2}}$$

The above φ(x, y₁, y₂, z₁, z₂) is the solution of the partial differential equation of the scattering field as shown in (2-7) below.

$$\begin{matrix}[ Math . 40 ] & \\ [ \frac{1}{4} {Δ}_{5}^{2} - {( ik )}^{2} {\partial }_{x}^{2} - ( {\partial }_{{y}_{1}}^{2} + {\partial }_{{z}_{1}}^{2} ) ( {\partial }_{{y}_{2}}^{2} + {\partial }_{{z}_{2}}^{2} ) ] ϕ = 0 & ( 2 - 7 )\end{matrix}$$

Next, the solution of Equation (2-7) is considered. First, by performing multiple Fourier transforms on φ with respect to t, x, y₁, and y₂ and performing conversion on Equation (2-7), (2-8) below is obtained. Here D_{z1} and D_{z2} denote partial derivatives related to z₁ and z₂, respectively.

$$\begin{matrix}[ Math . 41 ] & \\ \{ {( {D}_{{z}_{1}}^{2} + {D}_{{z}_{2}}^{2} - {k}_{x}^{2} - {k}_{{y}_{1}}^{2} - {k}_{{y}_{2}}^{2} )}^{2} - 4 {k}^{2} {k}_{x}^{2} - 4 ( {D}_{{z}_{1}}^{2} - {k}_{{y}_{1}}^{2} ) ( {D}_{{z}_{2}}^{2} - {k}_{{y}_{2}}^{2} ) \} \text{} \tilde{ϕ} = 0 & ( 2 - 8 )\end{matrix}$$

Equation (2-8) has four solutions, which are expressed as shown (2-9) below.

$$\begin{matrix}[ Math . 42 ] & \\ \begin{matrix}{E}_{1} ( {k}_{x} , {k}_{{y}_{1}} , {k}_{{y}_{2}} , {z}_{1} , {z}_{2} ) = exp \{ i ( {s}_{1} + {s}_{2} ) z \} \\ {E}_{2} ( {k}_{x} , {k}_{{y}_{1}} , {k}_{{y}_{2}} , {z}_{1} , {z}_{2} ) = exp \{ - i ( {s}_{1} + {s}_{2} ) z \} \\ {E}_{3} ( {k}_{x} , {k}_{{y}_{1}} , {k}_{{y}_{2}} , {z}_{1} , {z}_{2} ) = exp \{ i ( {s}_{1} - {s}_{2} ) z \} \\ {E}_{4} ( {k}_{x} , {k}_{{y}_{1}} , {k}_{{y}_{2}} , {z}_{1} , {z}_{2} ) = exp \{ i ( - {s}_{1} + {s}_{2} ) z \}\end{matrix} & ( 2 - 9 )\end{matrix}$$

Here, s₁ and s₂ are expressed as shown in (2-10) below.

$$\begin{matrix}[ Math . 43 ] & \\ {s}_{1} ( {k}_{x} , {k}_{{y}_{1}} , {k}_{{y}_{2}} ) = \frac{\sqrt{{k}^{2} - {k}_{{y}_{1}}^{2}} \sqrt{{( \sqrt{{k}^{2} - {k}_{{y}_{1}}^{2}} + \sqrt{{k}^{2} - {k}_{{y}_{2}}^{2}} )}^{2} - {k}_{x}^{2}}}{\sqrt{{k}^{2} - {k}_{{y}_{1}}^{2}} + \sqrt{{k}^{2} - {k}_{{y}_{2}}^{2}}} & ( 2 - 10 )\end{matrix}$$

$${s}_{2} ( {k}_{x} , {k}_{{y}_{1}} , {k}_{{y}_{2}} ) = \frac{\sqrt{{k}^{2} - {k}_{{y}_{2}}^{2}} \sqrt{{( \sqrt{{k}^{2} - {k}_{{y}_{1}}^{2}} + \sqrt{{k}^{2} - {k}_{{y}_{2}}^{2}} )}^{2} - {k}_{x}^{2}}}{\sqrt{{k}^{2} - {k}_{{y}_{1}}^{2}} + \sqrt{{k}^{2} - {k}_{{y}_{2}}^{2}}}$$

The scattering corresponding to each of the four fundamental solutions of Equation (2-9) is as illustrated in FIG. 2. Of these four fundamental solutions, E₃ and E₄ have a temporally retrograde relationship with each other, and are not independent from each other. Accordingly, E₁, E₂, and E₃ are independent fundamental solutions. The four general solutions of Equation (2-7) corresponding to the four fundamental solutions are expressed as shown in (2-11) below.

$$\begin{matrix}[ Math . 44 ] & \\ {ϕ}_{1} ( x , {y}_{1} , {y}_{2} , {z}_{1} , {z}_{2} , k ) = \frac{1}{{( 2 π )}^{3}} {{\int }^{∞}}_{- ∞} {{\int }^{∞}}_{- ∞} {{\int }^{∞}}_{- ∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} & ( 2 - 11 )\end{matrix}$$

$${ϕ}_{2} ( x , {y}_{1} , {y}_{2} , {z}_{1} , {z}_{2} , k ) = \frac{1}{{( 2 π )}^{3}} {{\int }^{∞}}_{- ∞} {{\int }^{∞}}_{- ∞} {{\int }^{∞}}_{- ∞} {e}^{- i ( {k}_{x} x + {k}_{{y}_{1}} {y}_{1} + {k}_{{y}_{2}} {y}_{2} )} {a}_{2} ( {k}_{x} , {k}_{{y}_{1}} , {k}_{{y}_{2}} ) \cdot {e}^{- {is}_{1} ( {k}_{x} , {k}_{{y}_{1}} , {k}_{{y}_{2}} ) {z}_{1}} {e}^{- {is}_{2} ( {k}_{x} , {k}_{{y}_{1}} , {k}_{{y}_{2}} ) {z}_{2}} {dk}_{x} {dk}_{{y}_{1}} {dk}_{{y}_{2}}$$

$${ϕ}_{3} ( x , {y}_{1} , {y}_{2} , {z}_{1} , {z}_{2} , k ) = \frac{1}{{( 2 π )}^{3}} {{\int }^{∞}}_{- ∞} {{\int }^{∞}}_{- ∞} {{\int }^{∞}}_{- ∞} {e}^{- i ( {k}_{x} x + {k}_{{y}_{1}} {y}_{1} + {k}_{{y}_{2}} {y}_{2} )} {a}_{3} ( {k}_{x} , {k}_{{y}_{1}} , {k}_{{y}_{2}} ) \cdot {e}^{{is}_{1} ( {k}_{x} , {k}_{{y}_{1}} , {k}_{{y}_{2}} ) {z}_{1}} {e}^{- {is}_{2} ( {k}_{x} , {k}_{{y}_{1}} , {k}_{{y}_{2}} ) {z}_{2}} {dk}_{x} {dk}_{{y}_{1}} {dk}_{{y}_{2}}$$

$${ϕ}_{4} ( x , {y}_{1} , {y}_{2} , {z}_{1} , {z}_{2} , k ) = \frac{1}{{( 2 π )}^{3}} {{\int }^{∞}}_{- ∞} {{\int }^{∞}}_{- ∞} {{\int }^{∞}}_{- ∞} {e}^{- i ( {k}_{x} x + {k}_{{y}_{1}} {y}_{1} + {k}_{{y}_{2}} {y}_{2} )} {a}_{4} ( {k}_{x} , {k}_{{y}_{1}} , {k}_{{y}_{2}} ) \cdot {e}^{- {is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}}$$

The four general solutions of Equation (2-11) shown above can be regarded as four scattering field functions corresponding to the four first-order scattering models illustrated in FIG. 2. The scattering field function corresponding to multiple scattering is derived based on the composition of the four scattering field functions.

### <III Multiple Scattering>

### <III-1 Multiple Scattering Orders>

The multiple scattering orders are as illustrated in FIG. 1. The multiple scattering of each order illustrated in FIG. 1 also includes different geometrical variations at the positions where the scattering occurs. The characteristics differ depending on the positive and negative signs of the z-coordinate component of each directional vector of incidence and scattering at the position where scattering occurs. The fact that the characteristics differ depending on the positive and negative signs of the z-coordinate component of each directional vector of incidence and scattering has been described in the fundamental solution of the scattering field in Chapter II.

### <III-2 Outline of Approach Using Scattering Field Theory of Multiple Scattering>

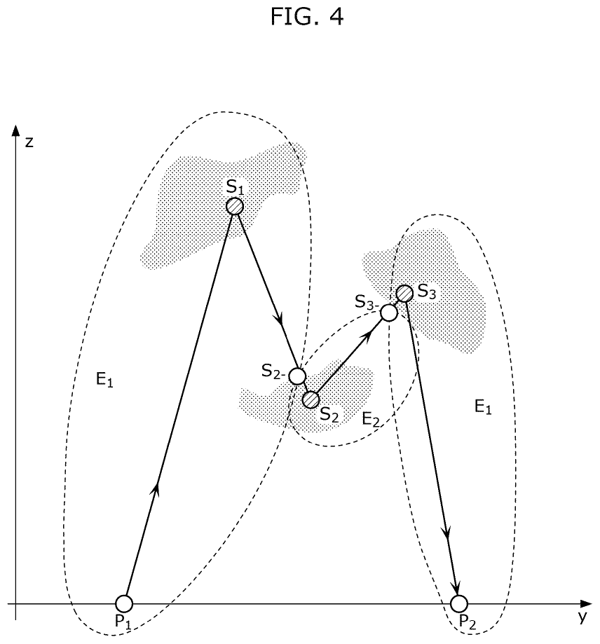

FIG. 4 is a conceptual diagram illustrating an application example of the fundamental solutions of the scattering field. Specifically, FIG. 4 illustrates a third-order scattering model to which a plurality of fundamental solutions are applied. For example, in the third-order scattering model illustrated in FIG. 4, the fundamental solutions E₁ and E₂ of the scattering field are used in the regions inside the dashed lines. The following (3-1) indicates the relations between the paths and the fundamental solutions.

$$\begin{matrix}[ Math . 45 ] & \\ \begin{matrix}{P}_{1} \to {S}_{1} \to {S}_{2 -} & : {E}_{1} \\ {S}_{2 -} \to {S}_{2} \to {S}_{3 -} & : {E}_{2} \\ {S}_{3 -} \to {S}_{3} \to {P}_{2} & : {E}_{1}\end{matrix} & ( 3 - 1 )\end{matrix}$$

Scattered points S₁, S₂, S₃ are arbitrary points in the regions, but the condition that the geometric rules are followed is imposed on scattered points S₁, S₂, S₃, and the like. Specifically, the sign of the z-coordinate component of the directional vector indicated by the arrow representing wave propagation in FIG. 4 is maintained. Moreover, P₁, P₂, S₂, and S₃ move within the measurement plane under the condition that their x coordinates are identical to each other.

In addition, the z coordinates of P₁ and P₂ are identical to each other. However, it is assumed that there are no restrictions on the x-coordinate of S₁.

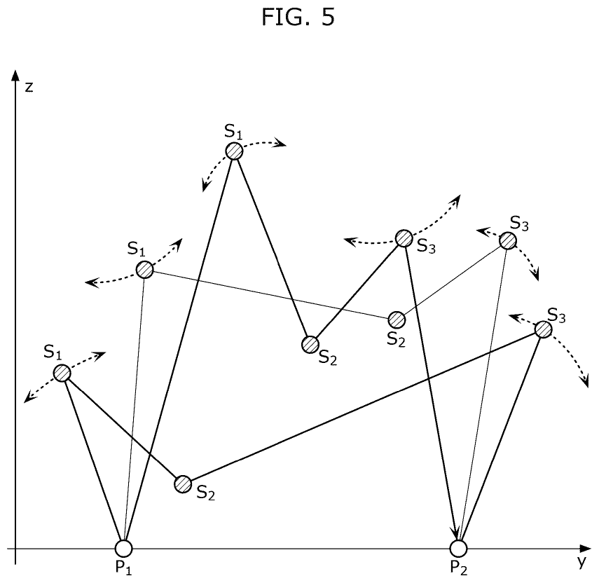

FIG. 5 illustrates wave propagation paths. Specifically, FIG. 5 illustrates a plurality of propagation paths for common transmission position P₁ and common reception point P₂ when the fundamental solutions E₁ and E₂ are used. These propagation paths conform to the above geometric rules.

The back scattering amplitude measured on the y-axis is expressed as shown in (3-2) below.

$$\begin{matrix}[ Math . 46 ] & \\ {Φ}_{1} ( {P}_{1} , {P}_{2} , k ) = {G}_{1} ( {P}_{1} , {P}_{2} , k ) + \int \int \int {G}_{1} ( {P}_{1} , {S}_{2 -} , k ) \cdot {G}_{2} ( {S}_{2 -} , {S}_{3 -} , k ) \cdot {G}_{1} ( {S}_{3 -} , {P}_{2} , k ) {dS}_{2} {dS}_{3} + … & ( 3 - 2 )\end{matrix}$$

Here, G (specifically, G₁ and G₂) is a Green's function, and is defined as shown in (3-3) below.

$$\begin{matrix}[ Math . 47 ] & \\ G ( {r}_{1} , {r}_{2} , ω ) = \int \int {\int }_{D} φ ( {r}_{1} \to ξ \to {r}_{2} , ω ) d ξ & ( 3 - 3 )\end{matrix}$$

Here,

$$φ ( {r}_{1} \to ξ \to {r}_{2} , ω ) \qquad [ Math . 48 ]$$

denotes the signal strength of the wave that exits r₁, is reflected at point ξ, and returns to point r₂. Suffixes 1 and 2 given to the Green's function correspond to the fundamental solutions E₁ and E₂. In a theory that does not consider multiple scattering, the equation in (3-4) below can be obtained ignoring the second and subsequent terms from the right side of Equation (3-2).

$$\begin{matrix}[ Math . 49 ] & \\ {G}_{1} ( {P}_{1} , {P}_{2} , k ) = {Φ}_{1} ( {P}_{1} , {P}_{2} , k ) & ( 3 - 4 )\end{matrix}$$

a₁(kₓ, k_{y1}, k_{y2}, k) in Equation (2-11) is obtained from Equation (3-4) by Fourier transform. By substituting the approximate function thus obtained into the integral sign on the right side of Equation (3-3), G₁(P₁, P₂, k) that takes into account multiple scattering is obtained, and more accurate a₁(kₓ, k_{y1}, k_{y2}, k) is obtained.

The right side of Equation (3-2) includes a new function G₂(S₂₋, S₃₋, k). In order to obtain this by measurement, the measurement result on a surface with a different z value than the one described above is used. When Φ₂(P₁, P₂, k) denotes the measurement result on a surface with a different z value, (3-5) below holds true.

$$\begin{matrix}[ Math . 50 ] & \\ {G}_{2} ( {P}_{1} , {P}_{2} , k ) = {Φ}_{2} ( {P}_{1} , {P}_{2} , k ) & ( 3 - 5 )\end{matrix}$$

With this, more accurate a₁(kₓ, k_{y1}, k_{y2}, k) is obtained from Equation (3-2).

### <III-3 Formulation of Inverse Scattering Problem in Multiple Scattering>

### (1) Second-Order Scattering

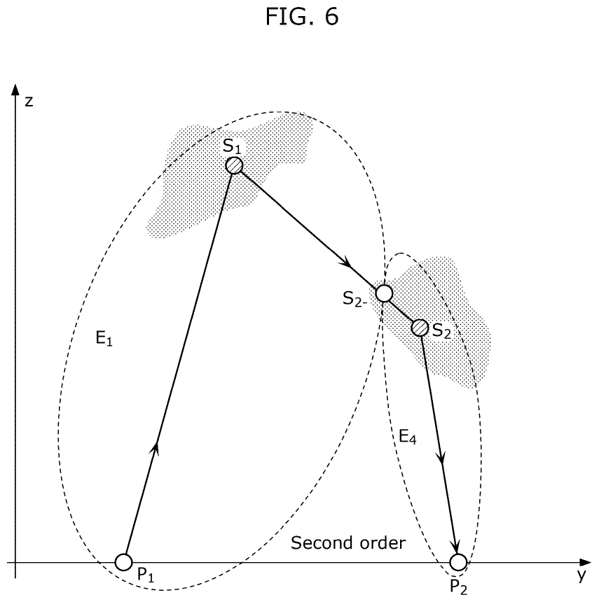

FIG. 6 is a conceptual diagram illustrating an application example of the fundamental solutions of a scattering field related to the second-order scattering. The second-order scattering corresponds to, as illustrated in FIG. 6, the form in which the fundamental solutions E₁ and E₄ of the scattering field equation are connected by S₂₋. S₂₋ is assumed to be as close as possible to S₂. The fundamental solutions E₃ and E₄ satisfy the condition that no direct wave propagating directly from S₂₋ to P₂ is included.

The paths of the second-order scattering are limited to the path illustrated in FIG. 6 and the path in which P₁ and P₂ in FIG. 6 are interchanged (symmetrically transformed path). The fundamental solutions E₁ and E₄ are applied as in FIG. 6, and the function names are given as (3-6) below.

$$\begin{matrix}[ Math . 51 ] & \\ \begin{matrix}{P}_{1} \to {S}_{1} \to {S}_{2 -} & : {ϕ}_{{P}_{1} {S}_{1} {S}_{2 -}} ( x , {y}_{1} , {η}_{2 -} , z , {ς}_{2 -} , k ) \\ {S}_{2 -} \to {S}_{2} \to {P}_{2} & : {ϕ}_{{S}_{2 -} {S}_{2} {P}_{2}} ( x , {η}_{2 -} , {y}_{2} , {ς}_{2 -} , z , k )\end{matrix} & ( 3 - 6 )\end{matrix}$$

Here (x, y₁, z) corresponds to the position of P₁, (x, y₂, z) corresponds to the position of P₂, and (x, η₂₋, ζ₂₋) corresponds to the position of S₂₋. The specific equation of (3-6) is expressed as shown in (3-7) below according to Equation (2-11).

$$\begin{matrix}[ Math . 52 ] & \\ {ϕ}_{{P}_{1} {S}_{1} {S}_{2 -}} ( x , {y}_{1} , {η}_{2 -} , z , {ς}_{2 -} , k ) = \frac{1}{{( 2 π )}^{3}} {{\int }^{∞}}_{- ∞} {{\int }^{∞}}_{- ∞} {{\int }^{∞}}_{- ∞} {e}^{- i ( {k}_{x} x + {k}_{{y}_{1}} {y}_{1} + {k}_{{η}_{2 -}} {η}_{2 -} )} {a}_{1} ( {k}_{x} , {k}_{{y}_{1}} , {k}_{{η}_{2 -}} , k ) \cdot {e}^{{is}_{1} ( {k}_{x} , {k}_{{y}_{1}} , {k}_{{η}_{2 -}} ) z} {e}^{{is}_{2} ( {k}_{x} , {k}_{{y}_{1}} , {k}_{{η}_{2 -}} ) {ς}_{2 -}} {dk}_{x} {dk}_{{y}_{1}} {dk}_{{η}_{2 -}} & ( 3 - 7 )\end{matrix}$$

$${ϕ}_{{S}_{2 -} {S}_{2} {P}_{2}} ( x , {η}_{2 -} , {y}_{2} , {ς}_{2 -} , z , k ) = \frac{1}{{( 2 π )}^{3}} {{\int }^{∞}}_{- ∞} {{\int }^{∞}}_{- ∞} {{\int }^{∞}}_{- ∞} {e}^{- i ( {k}_{x} x + {k}_{{η}_{2 -}} {η}_{2 -} + {k}_{{y}_{2}} {y}_{2} )} {a}_{4} ( {k}_{x} , {k}_{{η}_{2 -}} , {k}_{{y}_{2}} , k ) \cdot {e}^{- {is}_{1} ( {k}_{x} , {k}_{{η}_{2 -}} {k}_{{y}_{2}} , ) {ς}_{2 -}} {e}^{{is}_{2} ( {k}_{x} , {k}_{{η}_{2 -}} , {k}_{{y}_{2}} ) z} {dk}_{x} {dk}_{{η}_{2 -}} {dk}_{{y}_{2}}$$

The composition of the above functions corresponding to the second-order multiple scattering path P₁->S₁->S₂₋->S₂->P₂ is expressed as shown in (3-8) below.

$$\begin{matrix}[ Math . 53 ] & \\ {Φ}_{2} ( x , {y}_{1} , {y}_{2} , z , k ) = {ϕ}_{{P}_{1} {S}_{1} {S}_{2 -}} ( x , {y}_{1} , {η}_{2 -} , z , {ς}_{2 -} , k ) {ϕ}_{{S}_{2 -} {S}_{2} {P}_{2}} ( x , {η}_{2 -} , {y}_{2} , {ς}_{2 -} , z , k ) & ( 3 - 8 )\end{matrix}$$

By applying η₂₋->η and ζ₂₋->ζ to Equation (3-8) and performing integration with respect to the coordinates (η, ζ) of point S₂, (3-9) below is obtained.

$$\begin{matrix}[ Math . 54 ] & \\ {Ψ}_{2} ( x , {y}_{1} , {y}_{2} , z , k ) = \int \int {ϕ}_{{P}_{1} {S}_{1} {S}_{2 -}} ( x , {y}_{1} , η , z , ς , k ) {ϕ}_{{S}_{2 -} {S}_{2} {P}_{2}} ( x , η , {y}_{2} , ς , z , k ) d η d ς & ( 3 - 9 )\end{matrix}$$

By substituting Equation (3-7) into Equation (3-9), (3-10) below is obtained. In order to avoid confusion, suffixes such as a, b, + and − are appropriately given to variables in (3-10) below.

$$\begin{matrix}[ Math . 55 ] & \\ {Ψ}_{2} ( x , {y}_{1} , {y}_{2} , z , k ) = \frac{1}{{( 2 π )}^{6}} \int \int \int \int \int \int \int \int {e}^{- i ( {k}_{xa} x + {k}_{y 1} {y}_{1} + {k}_{{η}_{-}} η )} {a}_{1} ( {k}_{xa} , {k}_{{y}_{1}} , {k}_{{η}_{-}} , k ) \cdot {e}^{i {s}_{1} ( {k}_{xa} , {k}_{{y}_{1}} , {k}_{{η}_{-}} ) z} {e}^{{is}_{2} ( {k}_{xa} , {k}_{{y}_{1}} , {k}_{{η}_{-}} ) ζ} {dk}_{xa} {dk}_{{y}_{1}} {dk}_{{η}_{-}} \cdot {e}^{- i ( {k}_{sb} x + {k}_{{η}_{+}} η + {k}_{{y}_{2}} {y}_{2} )} {a}_{4} ( {k}_{sb} , {k}_{η} , {k}_{{y}_{2}} , k ) \cdot {e}^{- {is}_{1} ( {k}_{sb} , {k}_{{η}_{-}} , {k}_{{y}_{2}} ) ζ} {e}^{- {is}_{2} ( {k}_{sb} , {k}_{{η}_{-}} , {k}_{{y}_{2}} ) z} {dk}_{xb} {dk}_{η} , {dk}_{{y}_{2}} d η d ζ = \frac{1}{{( 2 π )}^{4}} \int \int \int \int \int \int {e}^{- i ( {k}_{xa} x + {k}_{{y}_{1}} {y}_{1} )} {e}^{- i ( {k}_{sb} x + {k}_{{y}_{2}} {y}_{2} )} \cdot δ ( {k}_{{η}_{-}} + {κ}_{{η}_{+}} ) δ ( {s}_{2} ( {k}_{xa} , {k}_{{y}_{1}} , {k}_{{η}_{-}} ) - {s}_{1} ( {k}_{sb} , {k}_{{η}_{+}} , {k}_{{y}_{2}} ) ) \cdot {a}_{1} ( {k}_{xa} , {k}_{{y}_{1}} , {k}_{{η}_{-}} , k ) {a}_{4} ( {k}_{xb} , {k}_{{η}_{+}} , {k}_{{y}_{2}} , k ) \cdot {e}^{{is}_{1} ( {k}_{xa} , {k}_{{y}_{1}} , {k}_{{η}_{-}} )} {e}^{{is}_{2} ( {k}_{xb} , {k}_{η +} , {k}_{{y}_{2}} ) z} {dk}_{xa} {dk}_{xb} {dk}_{{y}_{1}} {dk}_{{y}_{2}} {dk}_{η\_} {dk}_{{η}_{+}} & ( 3 - 10 )\end{matrix}$$

Here, δ denotes a delta function. δ(k_{η-}+k_{η+}) and δ(s2(kₓₐ, k_{y1}, k_{η-})−s1(k_{xb}, k_{η+}, k_{y2})) in Equation (3-10) have the same input and output at the connection point S₂₋. (3-11) below is obtained by Fourier transforming Equation (3-10) with respect to (x, y₁, y₂) at z=0.

$$\begin{matrix}[ Math . 56 ] & \\ {\tilde{Ψ}}_{2} ( {k}_{x} , {k}_{{y}_{1}}^{′} , {y}_{{y}_{2}}^{′} , 0 , k ) = \int \int \int {Ψ}_{2} ( x , {y}_{1} , {y}_{2} , z = 0 , k ) {e}^{{ik}_{x} x} {e}^{{ik}_{y 1}^{′} {y}_{1}} {e}^{{ik}_{y 2}^{′} y 2} {dxdy}_{1} {dy}_{2} = \frac{1}{( 2 π )} \int \int \int {a}_{1} ( {k}_{{x}_{a}} , {k}_{{y}_{1}}^{′} , {k}_{η} , k ) {a}_{4} ( {k}_{{x}_{b}} , - {k}_{η} , {k}_{{y}_{2}}^{′} , k ) \cdot δ ( {k}_{xa} + {k}_{xb} - {k}_{x} ) δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) \cdot {dk}_{{x}_{a}} {dk}_{{x}_{b}} {dk}_{η} & ( 3 - 11 )\end{matrix}$$

### (2) Third-Order Scattering

FIG. 4 illustrates an application example of the fundamental solutions of the scattering field related to the third-order scattering. Referring to FIG. 4, the scattering field functions as shown in (3-12) below are defined. The suffixes 2- and 3- given to η and ζ correspond to just before point S₂ and just before point S₃, respectively.

$$\begin{matrix}[ Math . 57 ] & \\ {P}_{1} \to {S}_{1} \to {S}_{2 -} : {ϕ}_{{P}_{1} {S}_{1} {S}_{2}} ( x , {y}_{1} , {η}_{2 -} , z , {ζ}_{2 -} , k ) & ( 3 - 12 )\end{matrix}$$

$${S}_{2 -} \to {S}_{2} \to {S}_{3 -} : {ϕ}_{{S}_{2 - 1} {S}_{1} {S}_{3 -}} ( x , {η}_{2 -} , {η}_{3 -} , {ζ}_{2 -} , {ζ}_{3 -} , k )$$

$${S}_{3} \to {S}_{3} \to {P}_{2} : {ϕ}_{{S}_{3 -} {S}_{3} {P}_{2}} ( x , {η}_{3} , {y}_{2} , {ζ}_{3} , z , k )$$

The functions on the right side in (3-12) correspond to the general solutions of the scattering field of first-order scattering, and are functions as shown in (3-13) below.

$$\begin{matrix}[ Math . 58 ] & \\ {ϕ}_{{P}_{1} {S}_{1} {S}_{2 -}} ( x , {y}_{1} , {η}_{2 -} , z , {ζ}_{2 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{η}_{2 -}} {η}_{2 -} )} {a}_{1} ( {k}_{x} , {k}_{{y}_{1}} , {k}_{{η}_{2 -}} , k ) \cdot {e}^{{is}_{1} ( {k}_{x} , {k}_{{y}_{1}} , {k}_{η 2 -} ) z} {e}^{{is}_{2} ( {k}_{x} , {k}_{{y}_{1}} , {k}_{{η}_{2 -}} ) {ζ}_{2 -}} {dk}_{x} {dk}_{{y}_{1}} {dk}_{{η}_{2 -}} & ( 3 - 13 )\end{matrix}$$

$${ϕ}_{{S}_{2 -} {S}_{2 +} {S}_{3 -}} ( x , {η}_{2 -} , {η}_{3 -} , {ζ}_{2 -} , {ζ}_{3 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{2 -}} {η}_{2 -} + {k}_{{η}_{3 -}} {η}_{3 -} )} {a}_{2} ( {k}_{x} , {k}_{{η}_{2 -}} , {k}_{{η}_{3 -}} , k ) \cdot {e}^{- {is}_{1} ( {k}_{x} , {k}_{{η}_{2 -}} , {k}_{{η}_{3 -}} ) {ζ}_{2 -}} {e}^{- {is}_{2} ( {k}_{x} , {k}_{{η}_{1}} , {k}_{{η}_{2}} ) {ζ}_{3 -}} {dk}_{x} {dk}_{{η}_{2 -}} {dk}_{{η}_{3 -}}$$

$${ϕ}_{{S}_{3 -} {S}_{3} {P}_{2}} ( x , {η}_{3 -} , {y}_{2} , {ζ}_{3 -} , z , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{3 -}} {η}_{3 -} + {k}_{{y}_{2}} {y}_{2} )} {a}_{1} ( {k}_{x} , {k}_{{η}_{3 -}} , {k}_{{y}_{2}} , k ) \cdot {e}^{{is}_{1} ( {k}_{x} , {k}_{{η}_{3 -}} , {k}_{{y}_{2}} ) {ζ}_{3 -}} {e}^{{is}_{2} ( {k}_{x} , {k}_{{η}_{3 -}} , {k}_{{y}_{2}} ) z} {dk}_{x} {dk}_{{η}_{3 -}} {dk}_{{y}_{2}}$$

The composition of the above equations corresponds to the third-order multiple scattering path P₁->S₁->S₂->S₃->P₂, which is expressed as shown in (3-14) below.

$$\begin{matrix}[ Math . 59 ] & \\ {Φ}_{3} ( x , {y}_{1} , {y}_{2} , z , k ) = {ϕ}_{{P}_{1} {S}_{1} {S}_{2 -}} ( x , {y}_{1} , {η}_{2 -} , z , {ζ}_{2 -} , k ) {ϕ}_{{S}_{2 -} {S}_{2} {S}_{3 -}} ( x , {η}_{2 -} , {η}_{3 -} , {ζ}_{2 -} , {ζ}_{3 -} , k ) \cdot {ϕ}_{{S}_{3 -} {S}_{3} {P}_{2}} ( x , {η}_{3 -} , {y}_{2} , {ζ}_{3 -} , z , k ) & ( 3 - 14 )\end{matrix}$$

By applying η₂₋->η₂, η₃₋->ζ₂₋-22 ζ₂ and ζ₃₋->ζ₃ to Equation (3-14) and performing integration with respect to the coordinates (η₂, ζ₂) and (η₃, ζ₃) at points S₂ and S₃, (3-15) below is obtained.

$$\begin{matrix}[ Math . 60 ] & \\ {Ψ}_{3} ( x , {y}_{1} , {y}_{2} , z , k ) = \int \int \int \int {ϕ}_{{P}_{1} {S}_{1} {S}_{2 -}} ( x , {y}_{1} , {η}_{2 -} , z , {ζ}_{2} , k ) {ϕ}_{{S}_{2 -} {S}_{2} {S}_{3 -}} ( x , {η}_{2} , {η}_{3} , {ζ}_{2} , {ζ}_{3} , k ) \cdot {ϕ}_{{S}_{3 -} {S}_{3} {P}_{2}} ( x , {η}_{3 -} , {y}_{2} , {ζ}_{3 -} , z , k ) d {η}_{2} d {ζ}_{2} d {η}_{3} d {ζ}_{3} & ( 3 - 15 )\end{matrix}$$

The function obtained by the above process denotes the third-order scattering amplitude as seen from P₁ and P₂. By substituting (3-13) into (3-15), (3-16) below is obtained. In (3-16) below, + and − are appropriately given to the suffix of wave number k to avoid confusion in the integral sign.

$$\begin{matrix}[ Math . 61 ] & \\ {Ψ}_{3} ( x , {y}_{1} , {y}_{2} , z , k ) = \frac{1}{{( 2 π )}^{3}} \int \int \int \int \int \int \int \int \int \int \int \int \int {e}^{- i ( {k}_{xa} x + {k}_{{y}_{3}} {y}_{1} + {k}_{{η}_{2 -}} {η}_{2 -} )} {a}_{1} ( {k}_{xa} , {k}_{{y}_{1}} , {k}_{{η}_{2 -}} , k ) \cdot {e}^{{is}_{1} ( {k}_{xa} , {k}_{{y}_{3}} , {k}_{{y}_{2 -}} ) z} {e}^{{is}_{2} ( {k}_{xa} , {k}_{{y}_{1}} , {k}_{{η}_{2 -}} ) {ζ}_{2}} {dk}_{xa} {dk}_{{y}_{1}} {dk}_{{η}_{2 -}} \cdot {e}^{- i ( {k}_{xb} x + {k}_{{η}_{2 +}} , {η}_{2} + {k}_{{η}_{3 -}} {η}_{3} )} {a}_{2} ( {k}_{xb} , {k}_{{η}_{2 +}} , {k}_{{η}_{3 -}} , k ) \cdot {e}^{- {is}_{1} ( {k}_{xb} + {k}_{{η}_{2 +}} , {k}_{η 3 -} ) {ζ}_{2}} {e}^{- {is}_{2} ( {k}_{xb} + {k}_{{η}_{2 +}} , {k}_{η 3 -} ) {ζ}_{3}} {dk}_{xb} {dk}_{{η}_{2 +}} {dk}_{{η}_{3 -}} \cdot {e}^{- i ( {k}_{xc} x + {k}_{{η}_{3 +} {η}_{3} +} {k}_{{y}_{2}} {y}_{2} )} {a}_{1} ( {k}_{xc} , {k}_{{η}_{3 +}} , {k}_{{y}_{2}} , k ) \cdot {e}^{{is}_{1} ( {k}_{xc} , {k}_{{η}_{3 -}} , {k}_{{y}_{2 -}} ) {ζ}_{3}} {e}^{{is}_{2} ( {k}_{xc} , {k}_{{η}_{3 +}} , {k}_{{y}_{2}} ) z} {dk}_{xc} {dl}_{{η}_{3 +}} {dk}_{{y}_{2}} d {η}_{2} d {ζ}_{2} d {η}_{3} d {ζ}_{3} & ( 3 - 16 )\end{matrix}$$

In the scattering field theory, there is a relational expression as shown in (3-17) below.

$$\begin{matrix}[ Ma th . 62 ] & \\ {s}_{1} ( {k}_{xb} , {k}_{{η}_{1 b}} , {k}_{{η}_{2 b}} ) + {s}_{2} ( {k}_{xb} , {k}_{{η}_{1 b}} , {k}_{{η}_{2 b}} ) = \sqrt{{( \sqrt{{k}^{2} - {k}_{{η}_{1 b}}^{2}} + \sqrt{{k}^{2} - {k}_{{η}_{2 b}}^{2}} )}^{2} - {k}_{xb}^{2}} & ( 3 - 17 )\end{matrix}$$

By performing integration with respect to η and ζ in (3-16), (3-18) below is obtained.

$$\begin{matrix}[ Math . 63 ] & \\ {Ψ}_{3} ( x , {y}_{1} , {y}_{2} , z , k ) = \frac{1}{{( 2 π )}^{9}} \int \int \int \int \int \int \int \int \int \int \int \int \int {e}^{- i ( {k}_{xa} x + {k}_{{y}_{1}} {y}_{1} + {k}_{{η}_{2 -}} {η}_{2} )} {a}_{1} ( {k}_{xa} , {k}_{{y}_{1}} , {k}_{{η}_{2 -}} , k ) \cdot {e}^{{is}_{1} ( {k}_{xa} , {k}_{{y}_{1}} , {k}_{{η}_{2 -}} ) z} {e}^{{is}_{2} ( {k}_{xa} , {k}_{{y}_{1}} , {k}_{{η}_{2 -}} ) {ζ}_{2}} {dk}_{xa} {dk}_{{y}_{1}} {dk}_{{η}_{2 -}} \cdot {e}^{- i ( {k}_{xb} x + {k}_{{η}_{2 +}} {η}_{2} + {k}_{{η}_{3 -}} {η}_{3} )} {a}_{2} ( {k}_{xb} , {k}_{{η}_{2}} , {k}_{{η}_{3 -}} , k ) \cdot {e}^{- {is}_{1} ( {k}_{xb} , {k}_{{η}_{2 +}} , {k}_{{η}_{3 -}} ) {ζ}_{2}} {e}^{- {is}_{2} ( {k}_{xb} , {k}_{{η}_{2 +}} , {k}_{{η}_{3 -}} ) {ζ}_{3}} {dk}_{xb} {dk}_{{η}_{2 +}} {dk}_{{η}_{3 -}} \cdot {e}^{- i ( {k}_{xc} x + {k}_{{η}_{3 +}} {η}_{3} + {k}_{{y}_{2}} {y}_{2} )} {a}_{1} ( {k}_{xc} , {k}_{{η}_{3 +}} , {k}_{{y}_{2}} , k ) \cdot {e}^{{is}_{1} ( {k}_{xc} , {k}_{{η}_{3 +}} , {k}_{{y}_{2}} ) {ζ}_{3}} {e}^{{is}_{2} ( {k}_{xc} , {k}_{{η}_{3 +}} , {k}_{{y}_{2}} ) z} {dk}_{xc} {dl}_{{η}_{3 +}} {dk}_{{y}_{2}} d {η}_{2} d {ζ}_{2} d {η}_{3} d {ζ}_{3} = \frac{1}{{( 2 π )}^{5}} \int \int \int \int \int \int \int \int \int {e}^{- i ( {k}_{xa} x + {k}_{{y}_{1}} {y}_{1} )} {e}^{- i ( {k}_{xb} x )} {e}^{- i ( {k}_{xc} x + {k}_{{y}_{2}} {y}_{2} )} \cdot {a}_{1} ( {k}_{xa} , {k}_{{y}_{1}} , {k}_{{η}_{2}} , k ) {a}_{2} ( {k}_{xb} , {k}_{{η}_{2 +}} , {k}_{{η}_{3 -}} , k ) {a}_{1} ( {k}_{xc} , {k}_{{η}_{3 +}} , {k}_{{y}_{2}} , k ) \cdot δ ( {k}_{{η}_{2 -}} + {k}_{{η}_{3 +}} ) δ ( {k}_{{η}_{3 -}} + {k}_{{η}_{3 +}} ) \cdot δ ( {s}_{1} ( {k}_{xb} , {k}_{{η}_{2 +}} , {k}_{{η}_{3 -}} ) - {s}_{2} ( {k}_{xa} , {k}_{{y}_{1}} , {k}_{{η}_{2 -}} ) ) \cdot δ ( {s}_{2} ( {k}_{xb} , {k}_{{η}_{2 +}} , {k}_{{η}_{3 -}} ) - {s}_{1} ( {k}_{xa} , {k}_{{η}_{3 +}} , {k}_{{y}_{2}} ) ) \cdot {e}^{{is}_{1} ( {k}_{xa} , {k}_{{y}_{1}} , {k}_{{η}_{2 -}} ) z} {e}^{{is}_{2} ( {k}_{xa} , {k}_{{η}_{3 +}} , {k}_{{y}_{2}} ) z} {dk}_{xa} {dk}_{xb} {dk}_{xc} {dk}_{{y}_{1}} {dk}_{{y}_{2}} {dk}_{{η}_{2 -}} {dk}_{{η}_{2 +}} {dk}_{{η}_{3 -}} {dk}_{{η}_{3 +}} = \frac{1}{{( 2 π )}^{5}} \int \int \int \int \int \int \int {e}^{- i ( {k}_{xa} x + {k}_{{y}_{1}} {y}_{1} )} {e}^{- i ( {k}_{xb} x )} {e}^{- i ( {k}_{xc} x + {k}_{{y}_{2}} {y}_{2} )} \cdot {a}_{1} ( {k}_{xa} , {k}_{{y}_{1}} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot ( {s}_{1} ( {k}_{xb} , {k}_{{η}_{2 +}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) \cdot {e}^{{is}_{1} ( {k}_{xa} , {k}_{{y}_{1}} , - {k}_{{η}_{2}} ) z} {e}^{{is}_{2} ( {k}_{xc} , {k}_{{η}_{3}} , {k}_{{y}_{2}} ) z} {dk}_{xa} {dk}_{xb} {dk}_{xc} {dk}_{{y}_{1}} {dk}_{{y}_{2}} {dk}_{{η}_{2}} {dk}_{{η}_{3}} & ( 3 - 18 )\end{matrix}$$

Here, δ denotes a delta function, which corresponds to the fact that the input and output match at the connection point. (3-19) below is obtained by Fourier transforming (3-18) with respect to (x, y₁, y₂) at z=0.

$$\begin{matrix}[ Math . 64 ] & \\ {\tilde{Ψ}}_{3} ( {k}_{x} , {k}_{{y}_{1}}^{′} , {k}_{{y}_{2}}^{′} , 0 , k ) = \int \int \int {Ψ}_{3} ( x , {y}_{1} , {y}_{2} , z = 0 , k ) {e}^{{ik}_{x} x} {e}^{{ik}_{y 1}^{′} {y}_{1}} {e}^{{ik}_{y 2}^{′} {y}_{2}} {dxdy}_{1} {dy}_{2} = \frac{1}{{( 2 π )}^{2}} \int \int \int \int \int {a}_{1} ( {k}_{xa} , {k}_{{y}_{1}}^{′} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , {k}_{{y}_{2}}^{′} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}}^{′} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}}^{′} ) ) {dk}_{xa} {dk}_{xb} {dk}_{xc} {dk}_{{η}_{2}} {dk}_{{η}_{3}} & ( 3 - 19 )\end{matrix}$$

The scattering field function ψ(x, y₁, y₂, z, k) is expressed as shown in (3-20) below when multiple scattering is considered.

$$\begin{matrix}[ Math . 65 ] & \\ Ψ ( x , {y}_{1} , {y}_{2} , z , k ) = {Ψ}_{1} ( x , {y}_{1} , {y}_{2} , z , k ) + {Ψ}_{2} ( x , {y}_{1} , {y}_{2} , z , k ) + {Ψ}_{3} ( x , {y}_{1} , {y}_{2} , z , k ) + … & ( 3 - 20 )\end{matrix}$$

Here, ψ₁ is a scattering field function corresponding to the first-order scattering, ψ₂ is a scattering field function corresponding to the second-order scattering, and ψ₃ is a scattering field function corresponding to the third-order scattering. Based on Equation (2-11) and the like, (3-21) below holds true.

$$\begin{matrix}[ Math . 66 ] & \\ \begin{matrix}{Ψ}_{1} ( x , {y}_{1} , {y}_{2} , 0 , k ) = {ϕ}_{1} ( x , {y}_{1} , {y}_{2} , 0 , k ) \\ = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} \\ {a}_{1} ( {k}_{x} , {k}_{{y}_{1}} , {k}_{{y}_{2}} , k ) {dk}_{x} {dk}_{{y}_{1}} {dk}_{{y}_{2}}\end{matrix} & ( 3 - 21 )\end{matrix}$$

For example, if the second term, and the fourth and subsequent terms on the right side in Equation (3-20) can be ignored, (3-22) below can be obtained by Fourier transforming the entire Equation (3-20).

$$\begin{matrix}[ Math . 67 ] & \\ \tilde{Ψ} ( {k}_{x} , {k}_{{y}_{1}} , {k}_{{y}_{2}} , 0 , k ) = \frac{1}{{( 2 π )}^{3}} {\int }_{- ∞}^{∞} {\int }_{- ∞}^{∞} {\int }_{- ∞}^{∞} {e}^{i ( {k}_{x} x + {k}_{{y}_{1}} {y}_{1} + {k}_{{y}_{2}} {y}_{2} )} \cdot \{ {Ψ}_{1} ( x , {y}_{1} , {y}_{2} , 0 , k ) + {Ψ}_{3} ( x , {y}_{1} , {y}_{2} , 0 , k ) \} {dxdy}_{1} {dy}_{2} = {a}_{1} ( {k}_{x} , {k}_{{y}_{1}} , {k}_{{y}_{2}} , k ) + \frac{1}{{( 2 π )}^{2}} \int \int \int \int \int {a}_{1} ( {k}_{xa} , {k}_{{y}_{1}}^{′} , - {k}_{{η}_{2}} , k ) {a}_{2} ( {k}_{xb} , {k}_{{η}_{2}} , - {k}_{{η}_{3}} , k ) \cdot {a}_{1} ( {k}_{xc} , {k}_{{η}_{3}} , {k}_{{y}_{2}} , k ) δ ( {k}_{xa} + {k}_{xb} + {k}_{xc} - {k}_{x} ) \cdot δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) \cdot {dk}_{xa} {dk}_{xb} {dk}_{xc} {dk}_{{η}_{1}} {dk}_{{η}_{3}} & ( 3 - 22 )\end{matrix}$$

Using the measurement data Φ₁(k) at z=0, the left side of Equation (3-22) can be expressed as shown in (3-23) below.

$$\begin{matrix}[ Math . 68 ] & \\ \tilde{Ψ} ( {k}_{x} , {y}_{1} , {y}_{2} , 0 , k ) = {Φ}_{1} ( {k}_{x} , {y}_{1} , {y}_{2} , k ) & ( 3 - 23 )\end{matrix}$$

The right side of Equation (3-23) is the measurement data on the boundary surface. Accordingly, the left side of Equation (3-22) is determined. Equation (3-22) is therefore a usual non-linear integral equation with respect to a₁(kₓ, k_{y1}, k_{y2}, k) and a₂(kₓ, k_{y1}, k_{y2}, k).

A similar equation can be obtained on another boundary surface expressed by z=h. Although this integral equation is nonlinear, the solution of the integral equation can be found very easily using the Neumann series expansion. The inverse scattering problem can be solved as if it were a forward scattering problem.

<III-4 Basic Equation of Inverse Scattering Problem with All Models Considered>

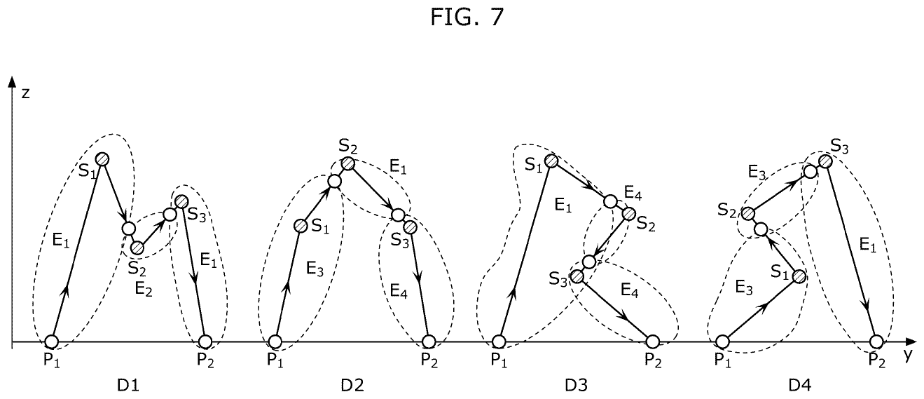

FIG. 7 illustrates four types of scattering models related to third-order scattering. Specifically, D1, D2, D3, and D4 in FIG. 7 correspond to four types of scattering models related to the third-order scattering. A scattering model can also be referred to as a scattering diagram. In FIG. 7, the regions to which the fundamental solutions E₁ to E₄ are applied are indicated by broken lines. (3-24), (3-25), (3-26), (3-27), and (3-28) below denote the scattering field functions of D1 to D4.

$$\begin{matrix}[ Math . 69 ] & \\ {P}_{1} \to {S}_{1} \to {S}_{2 -} : {ϕ}_{{P}_{1} {S}_{1} {S}_{2}} ( x , {y}_{1} , {η}_{2 -} , z , {ζ}_{2 -} , k ) & ( 3 - 24 )\end{matrix}$$

$${S}_{2 -} \to {S}_{2} \to {S}_{3 -} : {ϕ}_{{S}_{2 - 1} {S}_{1} {S}_{3 -}} ( x , {η}_{2 -} , {η}_{3 -} , {ζ}_{2 -} , {ζ}_{3 -} , k )$$

$${S}_{3 -} \to {S}_{3} \to {P}_{2} : {ϕ}_{{S}_{3 -} {S}_{3} {P}_{2}} ( x , {η}_{3 -} , {y}_{2} , {ζ}_{3 -} , z , k )$$

$$\begin{matrix}[ Math . 70 ] & \\ [ D 1 ] {ϕ}_{{P}_{1} {S}_{1} {S}_{2 -}} ( x , {y}_{1} , {η}_{2 -} , z , {ζ}_{2 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{2 -}} {η}_{2 -} + {k}_{{η}_{3 -}} {η}_{3 -} )} {a}_{1} ( {k}_{x} , {k}_{{y}_{1}} , {k}_{{η}_{2 -}} , k ) \cdot {e}^{{is}_{1} ( {k}_{x} , {k}_{{y}_{1}} , {k}_{{η}_{2 -}} ) z} {e}^{{is}_{2} ( {k}_{x} , {k}_{{y}_{1}} , {k}_{{η}_{2 -}} ) {ζ}_{2 -}} {dk}_{x} {dk}_{{y}_{1}} {dk}_{{η}_{2 -}} & ( 3 - 25 )\end{matrix}$$

$${ϕ}_{{S}_{2 -} {S}_{2} {S}_{3 -}} ( x , {η}_{2 -} , {η}_{3 -} , {ζ}_{2 -} , {ζ}_{3 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{2 -}} {η}_{2 -} + {k}_{{η}_{3 -}} {η}_{3 -} )} {a}_{2} ( {k}_{x} , {k}_{{η}_{2 -}} , {k}_{{η}_{3 -}} , k ) \cdot {e}^{- {is}_{1} ( {k}_{x} , {k}_{{η}_{2 -}} , {k}_{{η}_{3 -}} ) {ζ}_{2 -}} {e}^{- {is}_{2} ( {k}_{x} , {k}_{{η}_{2 -}} , {k}_{{η}_{3 -}} ) {ζ}_{3 -}} {dk}_{x} {dk}_{{η}_{2 -}} {dk}_{{η}_{3 -}}$$

$${ϕ}_{{S}_{3 -} {S}_{3} {P}_{2}} ( x , {η}_{3 -} , {y}_{2} , {ζ}_{3 -} , z , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{3 -}} {η}_{3 -} + {k}_{{y}_{2}} {y}_{2} )} {a}_{1} ( {k}_{x} , {k}_{{η}_{3 -}} , {k}_{{y}_{2}} , k ) \cdot {e}^{{is}_{1} ( {k}_{x} , {k}_{{η}_{3 -}} , {k}_{{y}_{2}} ) {ζ}_{3 -}} {e}^{{is}_{2} ( {k}_{x} , {k}_{{η}_{3 -}} , {k}_{{y}_{2}} ) z} {dk}_{x} {dk}_{{η}_{3 -}} {dk}_{{y}_{2}}$$

$$\begin{matrix}[ Math . 71 ] & \\ [ D 2 ] {ϕ}_{{P}_{1} {S}_{1} {S}_{2 -}} ( x , {y}_{1} , {η}_{2 -} , z , {ζ}_{2 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{η}_{2 -}} {η}_{2} )} {a}_{3} ( {k}_{x} , {k}_{{y}_{1}} , {k}_{{η}_{2 -}} , k ) \cdot {e}^{{ix}_{1} ( {k}_{x} , {k}_{{y}_{1}} , {k}_{{η}_{2 -}} ) z} {e}^{{ix}_{2} ( {k}_{x} , {k}_{{y}_{1}} , {k}_{{η}_{2 -}} ) {ζ}_{2 -}} {dk}_{x} {dk}_{{y}_{1}} {dk}_{{η}_{2 -}} & ( 3 - 26 )\end{matrix}$$

$${ϕ}_{{S}_{2 -} {S}_{2} {S}_{3 -}} ( x , {η}_{2} , {η}_{3} , {ζ}_{2} , {ζ}_{3} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{2 -}} {η}_{2 -} + {k}_{{η}_{3 -}} {η}_{3 -} )} {a}_{1} ( {k}_{x} , {k}_{{η}_{2 -}} , {k}_{{η}_{3 -}} , k ) \cdot {e}^{{is}_{1} ( {k}_{x} , {k}_{{η}_{2 -}} , {k}_{{η}_{3 -}} ) {ζ}_{2 -}} {e}^{{is}_{2} ( {k}_{x} , {k}_{{η}_{2 -}} , {k}_{{η}_{3 -}} ) {ζ}_{3 -}} {dk}_{x} {dk}_{{η}_{2 -}} {dk}_{{η}_{3 -}}$$

$${ϕ}_{{S}_{3 -} {S}_{3} {P}_{2}} ( x , {η}_{3 -} , {y}_{2} , {ζ}_{3 -} , z , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{3 -}} {η}_{3 -} + {k}_{{y}_{2}} {y}_{2} )} {a}_{4} ( {k}_{x} , {k}_{{η}_{3 -}} , {k}_{{y}_{2}} , k ) \cdot {e}^{- {is}_{1} ( {k}_{x} , {k}_{{η}_{3 -}} , {k}_{{y}_{2}} ) {ζ}_{3 -}} {e}^{{is}_{2} ( {k}_{x} , {k}_{{η}_{3 -}} , {k}_{{y}_{2}} ) z} {dk}_{x} {dk}_{{η}_{3 -}} {dk}_{{y}_{2}}$$

$$\begin{matrix}[ Math . 72 ] & \\ [ D 3 ] {ϕ}_{{P}_{1} {S}_{1} {S}_{2 -}} ( x , {y}_{1} , {η}_{2 -} , z , {ζ}_{2 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{η}_{2 -}} {η}_{2 -} )} {a}_{1} ( {k}_{x} , {k}_{{y}_{1}} , {k}_{{η}_{2 -}} , k ) \cdot {e}^{{is}_{1} ( {k}_{x} , {k}_{{y}_{1}} , {k}_{{η}_{2 -}} ) z} {e}^{{is}_{2} ( {k}_{x} , {k}_{{y}_{1}} , {k}_{{η}_{2 -}} ) {ζ}_{2 -}} {dk}_{x} {dk}_{{y}_{1}} {dk}_{{η}_{2 -}} & ( 3 - 27 )\end{matrix}$$

$${ϕ}_{{S}_{2 -} {S}_{2} {S}_{3 -}} ( x , {η}_{2 -} , {η}_{3 -} , {ζ}_{2 -} , {ζ}_{3 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{2 -}} {η}_{2 -} + {k}_{{η}_{3 -}} {η}_{3 -} )} {a}_{4} ( {k}_{x} , {k}_{{η}_{2 -}} , {k}_{{η}_{3 -}} , k ) \cdot {e}^{- {is}_{1} ( {k}_{x} , {k}_{{η}_{2 -}} , {k}_{{η}_{3 -}} ) {ζ}_{2 -}} {e}^{{is}_{2} ( {k}_{x} , {k}_{{η}_{2 -}} , {k}_{{η}_{3 -}} ) {ζ}_{3 -}} {dk}_{x} {dk}_{{η}_{2 -}} {dk}_{{η}_{3 -}}$$

$${ϕ}_{{S}_{2} {S}_{3} {P}_{2}} ( x , {η}_{3 -} , {y}_{2} , {ζ}_{3 -} , z , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{3 -}} {η}_{3 -} + {k}_{{y}_{2}} {y}_{2} )} {a}_{4} ( {k}_{x} , {k}_{{η}_{3 -}} , {k}_{{y}_{2}} , k ) \cdot {e}^{- {is}_{1} ( {k}_{x} , {k}_{{η}_{3 -}} , {k}_{{y}_{2}} ) {ζ}_{3 -}} {e}^{{is}_{2} ( {k}_{x} , {k}_{{η}_{3 -}} , {k}_{{y}_{2}} ) z} {dk}_{x} {dk}_{{η}_{3 -}} {dk}_{{y}_{2}}$$

$$\begin{matrix}[ Math . 73 ] & \\ [ D 4 ] {ϕ}_{{P}_{1} {S}_{1} {S}_{2 -}} ( x , {y}_{1} , {η}_{2 -} , z , {ζ}_{2 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{η}_{2 -}} {η}_{2 -} )} {a}_{3} ( {k}_{x} , {k}_{{y}_{1}} , {k}_{{η}_{2 -}} , k ) \cdot {e}^{{is}_{1} ( {k}_{x} , {k}_{{y}_{1}} , {k}_{{η}_{2 -}} ) z} {e}^{- {is}_{2} ( {k}_{x} , {k}_{{y}_{1}} , {k}_{{η}_{2 -}} ) {ζ}_{2 -}} {dk}_{x} {dk}_{{y}_{1}} {dk}_{{η}_{2 -}} & ( 3 - 28 )\end{matrix}$$

$${ϕ}_{{S}_{2 -} {S}_{2} {S}_{3 -}} ( x , {η}_{2 -} , {η}_{3 -} , {ζ}_{2 -} , {ζ}_{3 -} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{2 -}} {η}_{2 -} + {k}_{{η}_{3 -}} {η}_{3 -} )} {a}_{3} ( {k}_{x} , {k}_{{η}_{2 -}} , {k}_{{η}_{3 -}} , k ) \cdot {e}^{{is}_{1} ( {k}_{x} , {k}_{{η}_{2 -}} , {k}_{{η}_{3 -}} ) {ζ}_{2 -}} {e}^{- {is}_{2} ( {k}_{x} , {k}_{{η}_{2 -}} , {k}_{{η}_{3 -}} ) {ζ}_{3 -}} {dk}_{x} {dk}_{{η}_{2 -}} {dk}_{{η}_{3 -}}$$

$${ϕ}_{{S}_{2} {S}_{3} {P}_{2}} ( x , {η}_{3 -} , {y}_{2} , {ζ}_{3 -} , z , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{η}_{3 -}} {η}_{3 -} + {k}_{{y}_{2}} {y}_{2} )} {a}_{1} ( {k}_{x} , {k}_{{η}_{3 -}} , {k}_{{y}_{2}} , k ) \cdot {e}^{{is}_{1} ( {k}_{x} , {k}_{{η}_{3 -}} , {k}_{{y}_{2}} ) {ζ}_{3 -}} {e}^{{is}_{2} ( {k}_{x} , {k}_{{η}_{3 -}} , {k}_{{y}_{2}} ) z} {dk}_{x} {dk}_{{η}_{3 -}} {dk}_{{y}_{2}}$$

In the above equations, (η₂₋, ζ₂₋) and (η₃₋, ζ₃₋) denote the coordinates of the point immediately before point S₂ and the point immediately before point S₃, respectively.

The composition of the above functions corresponds to the third-order multiple scattering path P₁->S₁->S₂->S₃->P₂, which is expressed as shown in (3-29) below.

$$\begin{matrix}[ Math . 74 ] & \\ {Φ}_{3} ( x , {y}_{1} , {y}_{2} , z , k ) = {ϕ}_{{P}_{1} {S}_{1} {S}_{2 -}} ( x , {y}_{1} , {η}_{2 -} , z , {ζ}_{2 -} , k ) \text{} {ϕ}_{{S}_{2 -} {S}_{2} {S}_{3 -}} ( x , {η}_{2 -} , {η}_{3 -} , {ζ}_{2 -} , {ζ}_{2 -} , k ) \cdot {ϕ}_{{S}_{3 -} {S}_{3} {P}_{2}} ( x , {η}_{3 -} , {y}_{2} , {ζ}_{3 -} , z , k ) & ( 3 - 29 )\end{matrix}$$

By applying η₂₋->η₂, η₃₋->η₃, ζ₂₋->ζ₂ and ζ₃₋->ζ₃ to Equation (3-29) and performing integration with respect to the coordinates (η₂, ζ₂) and (η₃, ζ₃) at points S₂ and S₃, (3-30) below is obtained.

$$\begin{matrix}[ Math . 75 ] & \\ {Ψ}_{3} ( x , {y}_{1} , {y}_{2} , z , k ) = \int \int \int \int {ϕ}_{{P}_{1} {S}_{1} {S}_{2 -}} ( x , {y}_{1} , {η}_{2} , z , {ζ}_{2} , k ) {ϕ}_{{S}_{2 -} {S}_{2} {S}_{3 -}} ( x , {η}_{2} , \text{} {η}_{3} , {ζ}_{2} , {ζ}_{3} , k ) \cdot {ϕ}_{{S}_{3 -} {S}_{3} {P}_{2}} ( x , {η}_{3 -} , {y}_{2} , {ζ}_{3 -} , z , k ) d {η}_{2} d {ζ}_{2} d {η}_{3} d {ζ}_{3} & ( 3 - 30 )\end{matrix}$$

By performing integration with respect to (η₂, ζ₂) and (η₃, ζ₃) in (3-30) and Fourier transforming the results with respect to (x, y₁, y₂) at z=0, (3-31), (3-32), (3-33) and (3-34) below are obtained.

$$\begin{matrix}[ Math . 76 ] [ D1 ] & \\ {\tilde{Ψ}}_{3} ( {k}_{x} , {k}_{{y}_{1}}^{′} , {k}_{{y}_{2}}^{′} , 0 , k ) = \int \int \int {Ψ}_{3} ( x , {y}_{1} , {y}_{2} , z = 0 , k ) {e}^{{ik}_{x} x} {e}^{{ik}_{y 1}^{′} {y}_{1}} {e}^{{ik}_{y 2}^{′} {y}_{2}} {dxdy}_{1} {dy}_{2} = \frac{1}{{( 2 π )}^{2}} \int \int \int \int \int {a}_{1} ( {k}_{xa} , {k}_{{y}_{1}}^{′} , - {k}_{{η}_{2}} , k ) \text{} {a}_{2} ( {k}_{xb} , {k}_{{η}_{2}} , - {k}_{{η}_{3}} , k ) \text{} {a}_{1} ( {k}_{xc} , {k}_{{η}_{3}} , {k}_{{y}_{2}}^{′} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}}^{′} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}}^{′} ) ) {dk}_{xa} {dk}_{xb} {dk}_{xc} {dk}_{{η}_{2}} {dk}_{{η}_{3}} & ( 3 - 31 )\end{matrix}$$

$$\begin{matrix}[ Math . 77 ] [ D2 ] & \\ {\tilde{Ψ}}_{3} ( {k}_{x} , {k}_{{y}_{1}}^{′} , {k}_{{y}_{2}}^{′} , 0 , k ) = \int \int \int {Ψ}_{3} ( x , {y}_{1} , {y}_{2} , z = 0 , k ) {e}^{{ik}_{x} x} {e}^{{ik}_{y 1}^{′} {y}_{1}} {e}^{{ik}_{y 2}^{′} {y}_{3}} {dxdy}_{1} {dy}_{2} = \frac{1}{{( 2 π )}^{2}} \int \int \int \int \int {a}_{3} ( {k}_{xa} , {k}_{{y}_{1}}^{′} , - {k}_{{η}_{2}} , k ) \text{} {a}_{1} ( {k}_{xb} , {k}_{{η}_{2}} , - {k}_{{η}_{3}} , k ) \text{} {a}_{4} ( {k}_{xc} , {k}_{{η}_{3}} , {k}_{{y}_{2}}^{′} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}}^{′} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}}^{′} ) ) {dk}_{xa} {dk}_{xb} {dk}_{xc} {dk}_{{η}_{2}} {dk}_{{η}_{3}} & ( 3 - 32 )\end{matrix}$$

$$\begin{matrix}[ Math . 78 ] [ D3 ] & \\ {\tilde{Ψ}}_{3} ( {k}_{x} , {k}_{{y}_{1}}^{′} , {k}_{{y}_{2}}^{′} , 0 , k ) = \int \int \int {Ψ}_{3} ( x , {y}_{1} , {y}_{2} , z = 0 , k ) {e}^{{ik}_{x} x} {e}^{{ik}_{y 1}^{′} {y}_{1}} {e}^{{ik}_{y 2}^{′} {y}_{2}} {dxdy}_{1} {dy}_{2} = \frac{1}{{( 2 π )}^{2}} \int \int \int \int \int {a}_{1} ( {k}_{xa} , {k}_{{y}_{1}}^{′} , - {k}_{{η}_{2}} , k ) \text{} {a}_{4} ( {k}_{xb} , {k}_{{η}_{2}} , - {k}_{{η}_{3}} , k ) \text{} {a}_{4} ( {k}_{xc} , {k}_{{η}_{3}} , {k}_{{y}_{2}}^{′} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}}^{′} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}}^{′} ) ) {dk}_{xa} {dk}_{xb} {dk}_{xc} {dk}_{{η}_{2}} {dk}_{{η}_{3}} & ( 3 - 33 )\end{matrix}$$

$$\begin{matrix}[ Math . 79 ] [ D4 ] & \\ {\tilde{Ψ}}_{3} ( {k}_{x} , {k}_{{y}_{1}}^{′} , {k}_{{y}_{2}}^{′} , 0 , k ) = \int \int \int {Ψ}_{3} ( x , {y}_{1} , {y}_{2} , z = 0 , k ) {e}^{{ik}_{x} x} {e}^{{ik}_{y 1}^{′} {y}_{1}} {e}^{{ik}_{y 2}^{′} {y}_{2}} {dxdy}_{1} {dy}_{2} = \frac{1}{{( 2 π )}^{2}} \int \int \int \int \int {a}_{3} ( {k}_{xa} , {k}_{{y}_{1}}^{′} , - {k}_{{η}_{2}} , k ) \text{} {a}_{3} ( {k}_{xb} , {k}_{{η}_{2}} , - {k}_{{η}_{3}} , k ) \text{} {a}_{1} ( {k}_{xc} , {k}_{{η}_{3}} , {k}_{{y}_{2}}^{′} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}}^{′} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}}^{′} ) ) {dk}_{xa} {dk}_{xb} {dk}_{xc} {dk}_{{η}_{2}} {dk}_{{η}_{3}} & ( 3 - 34 )\end{matrix}$$

### <III-5 Integral Equation of Inverse Scattering Problem in Multiple Scattering>

The scattering field function ψ(x, y₁, y₂, z, k) is expressed as shown in (3-35) below when multiple scattering is considered.

$$\begin{matrix}[ Math . 80 ] & \\ Ψ ( x , {y}_{1} , {y}_{2} , z , k ) = {Ψ}_{1} ( x , {y}_{1} , {y}_{2} , z , k ) + {Ψ}_{2} ( x , {y}_{1} , {y}_{2} , z , k ) + {Ψ}_{3} ( x , {y}_{1} , {y}_{2} , z , k ) + … & ( 3 - 35 )\end{matrix}$$

By Fourier transforming the entire Equation (3-35) at z=0, (3-36) and (3-37) below are obtained.

$$\begin{matrix}[ Math . 81 ] & \\ \tilde{Ψ} ( {k}_{x} , {k}_{{y}_{1}} , {k}_{{y}_{2}} , 0 , k ) = \frac{1}{{( 2 π )}^{3}} {{\int }_{- ∞}}^{∞} {{\int }_{- ∞}}^{∞} {{\int }_{- ∞}}^{∞} {e}^{i ( {k}_{x} x + {k}_{{y}_{1}} {y}_{1} + {k}_{{y}_{2}} {y}_{2} )} \cdot \{ {Ψ}_{1} ( x , {y}_{1} , {y}_{2} , 0 , k ) + {Ψ}_{2} ( x , {y}_{1} , {y}_{2} , 0 , k ) + {Ψ}_{3} ( x , {y}_{1} , {y}_{2} , 0 , k ) + … \} \cdot {dxdy}_{1} {dy}_{2} & ( 3 - 36 )\end{matrix}$$

$$\begin{matrix}[ Math . 82 ] & \\ \tilde{Ψ} ( {k}_{x} , {k}_{{y}_{1}} , {k}_{{y}_{2}} , 0 , k ) = {a}_{1} ( {k}_{x} , {k}_{{y}_{1}} , {k}_{{y}_{2}} , k ) + \frac{1}{( 2 π )} \text{} \int \int \int {a}_{1} ( {k}_{{x}_{a}} , {k}_{{y}_{1}}^{′} , {k}_{η} , k ) {a}_{4} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} + \frac{1}{{( 2 π )}^{2}} \int \int \int \int \int {a}_{1} ( {k}_{xa} , {k}_{{y}_{1}}^{′} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{1} ( {k}_{xb} , {k}_{{η}_{2}} , - {k}_{{η}_{3}} , k ) {a}_{4} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{1} ( {k}_{xa} , {k}_{{y}_{1}} , - {k}_{{η}_{2}} , k ) {a}_{4} ( {k}_{xb} , {k}_{{η}_{2}} , - {k}_{{η}_{3}} , k ) {a}_{4} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{3} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{1} ( {k}_{xb} , {k}_{{η}_{2}} - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + O ( {a}^{4} ) & ( 3 - 37 )\end{matrix}$$

Here,

$$\tilde{Ψ} ( {k}_{x} , {k}_{{y}_{1}} , {k}_{{y}_{2}} , 0 , k ) \qquad [ Math . 83 ]$$

is a measurement value of the multistatic radar at z=0. Accordingly, (3-37) is an integral equation with respect to a₁ (kₓ, k_{y1}, k_{y2}, k), a₂ (kₓ, k_{y1}, k_{y2}, k), a₃ (kₓ, k_{y1}, k_{y2}, k), and a₄ (kₓ, k_{y1}, k_{y2}, k).

In order to solve the integral equation including the multiple scattering terms, measurement values on two z=const planes are used. It is extremely easy to solve this integral equation based on the measurement values. The result is obtained in the form of a Neumann series. Note that O(a⁴) in Equation (3-37) is the term corresponding to the fourth-order or higher-order scattering, and may be omitted.

### <III-6 Solution of Integral Equation of Inverse Scattering Problem in Multiple Scattering>

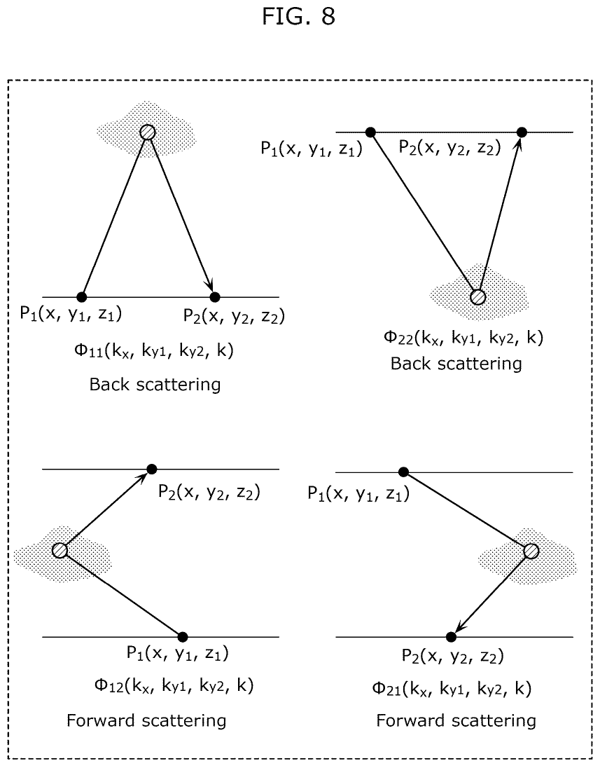

FIG. 8 illustrates definitions of four types of measurement data. In other words, four types of measurement data of multistatic scattering tomography are defined as in FIG. 8. From (3-31), (3-32), (3-33), (3-34), and the like, (3-38) below hold true.

$$\begin{matrix}[ Math . 84 ] & \\ {Φ}_{11} ( {k}_{x} , {k}_{{y}_{1}} , {k}_{{y}_{2}} , k ) = {\tilde{Ψ}}_{11} ( {k}_{x} , {k}_{{y}_{1}} , {k}_{{y}_{2}} , 0 , k ) & ( 3 - 38 )\end{matrix}$$

$${Φ}_{22} ( {k}_{x} , {k}_{{y}_{1}} , {k}_{{y}_{2}} , k ) = {\tilde{Ψ}}_{22} ( {k}_{x} , {k}_{{y}_{1}} , {k}_{{y}_{2}} , h , k )$$

$${Φ}_{12} ( {k}_{x} , {k}_{{y}_{1}} , {k}_{{y}_{2}} , k ) = {\tilde{Ψ}}_{12} ( {k}_{x} , {k}_{{y}_{1}} , {k}_{{y}_{2}} , h , k )$$

$${Φ}_{21} ( {k}_{x} , {k}_{{y}_{1}} , {k}_{{y}_{2}} , k ) = {\tilde{Ψ}}_{21} ( {k}_{x} , {k}_{{y}_{1}} , {k}_{{y}_{2}} , 0 , k )$$

The right sides of the four equations in (3-38) express four types of functions obtained by Fourier transforming the four types of scattering field functions of multiple scattering corresponding to four types of measurement methods.

Equation (3-37) yields a¹(kₓ, k_{y1}, k_{y2}, k) when multiple scattering is not considered. In the following, a suffix of “0” is given to each solution in which multiple scattering is not considered. The results as in (3-39) below are obtained corresponding to the four types of measurement data in FIG. 8.

$$\begin{matrix}[ Math . 85 ] & \\ {a}_{1 , 0} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) & ( 3 - 39 )\end{matrix}$$

$${a}_{2 , 0} ( {k}_{x} , {k}_{{y}_{1}} , {k}_{{y}_{2}} , k ) = {Φ}_{22} ( {k}_{x} , {k}_{{y}_{1}} , {k}_{{y}_{2}} , k )$$

$${a}_{3 , 0} ( {k}_{x} , {k}_{{y}_{1}} , {k}_{{y}_{2}} , k ) = {Φ}_{12} ( {k}_{x} , {k}_{{y}_{1}} , {k}_{{y}_{2}} , k )$$

$${a}_{4 , 0} ( {k}_{x} , {k}_{{y}_{1}} , {k}_{{y}_{2}} , k ) = {Φ}_{21} ( {k}_{x} , {k}_{{y}_{1}} , {k}_{{y}_{2}} , k )$$

By expanding a₁, a₂, a₃, and a₄ to the series corresponding to the scattering orders, (3-40) below is obtained. Note that a suffix related to the order of scattering is given to each of a₁, a₂, a₃, and a₄.

$$\begin{matrix}[ Math . 86 ] & \\ {a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) + {a}_{1 , 1} ( {k}_{x} , {k}_{{y}_{1}} , {k}_{{y}_{2}} , k ) + {a}_{1 , 2} ( \text{} {k}_{x} , {k}_{{y}_{1}} , {k}_{{y}_{2}} , k ) + ... . {a}_{2} ( {k}_{x} , {k}_{{y}_{1}} , {k}_{{y}_{2}} , k ) = {Φ}_{22} ( {k}_{x} , {k}_{{y}_{1}} , {k}_{{y}_{2}} , k ) + {a}_{2 , 1} ( {k}_{x} , {k}_{{y}_{1}} , {k}_{{y}_{2}} , k ) + {a}_{2 , 2} ( {k}_{x} , {k}_{{y}_{1}} , {k}_{{y}_{2}} , k ) + ... . {a}_{3} ( {k}_{x} , {k}_{{y}_{1}} , {k}_{{y}_{2}} , k ) = {Φ}_{12} ( {k}_{x} , {k}_{{y}_{1}} , {k}_{{y}_{2}} , k ) + {a}_{3 , 1} ( {k}_{x} , {k}_{{y}_{1}} , {k}_{{y}_{2}} , k ) + {a}_{3 , 2} ( {k}_{x} , {k}_{{y}_{1}} , {k}_{{y}_{2}} , k ) + ... . {a}_{4} ( {k}_{x} , {k}_{{y}_{1}} , {k}_{{y}_{2}} , k ) = {Φ}_{21} ( {k}_{x} , {k}_{{y}_{1}} , {k}_{{y}_{2}} , k ) + {a}_{4 , 1} ( {k}_{x} , {k}_{{y}_{1}} , {k}_{{y}_{2}} , k ) + {a}_{4 , 2} ( {k}_{x} , {k}_{{y}_{1}} , {k}_{{y}_{2}} , k ) + ... . & ( 3 - 40 )\end{matrix}$$

By substituting the measurement data expressed by (3-38) into (3-37), (3-41) below can be obtained.

$$\begin{matrix}[ Math . 87 ] & \\ {Φ}_{11} ( {k}_{x} , {k}_{{y}_{1}} , {k}_{{y}_{2}} , k ) = {a}_{1} ( {k}_{x} , {k}_{{y}_{1}} , {k}_{{y}_{2}} , k ) + \frac{1}{( 2 π )} \text{} \int \int \int {a}_{1} ( {k}_{{x}_{a}} , {k}_{{y}_{1}} , {k}_{η} , k ) {a}_{4} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} + \frac{1}{{( 2 π )}^{2}} \int \int \int \int \int {a}_{1} ( {k}_{xa} , {k}_{{y}_{1}} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{1} ( {k}_{xb} , {k}_{{η}_{2}} , - {k}_{{η}_{3}} , k ) {a}_{4} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{3}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{1} ( {k}_{xa} , {k}_{{y}_{1}} , - {k}_{{η}_{2}} , k ) {a}_{4} ( {k}_{xb} , {k}_{{η}_{2}} , - {k}_{{η}_{3}} , k ) {a}_{4} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{3} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + O ( {a}^{4} ) & ( 3 - 41 )\end{matrix}$$

From this Equation (3-41), it is possible to express a_{1,1}(kₓ, k_{y1}, k_{y2}, k) related to second-order scattering using only the measurement data. Similar equations are also obtained for the other a_{2, 1}, a_{3, 1}, a_{4, 1}.

By substituting (3-40) into (3-41) and leaving only the 0^{th}-order term in the integral sign, (3-42) below is obtained.

$$\begin{matrix}[ Math . 88 ] & \\ {a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{( 2 π )} \text{} \int \int \int {Φ}_{21} ( {k}_{{x}_{a}} , {k}_{{y}_{1}} , {k}_{η} , k ) {Φ}_{21} ( {k}_{{x}_{b}} , - {k}_{η} , {k}_{{y}_{2}} , k ) δ ( \text{} {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{11} ( {k}_{xa} , {k}_{{y}_{1}} , - {k}_{{η}_{2}} , k ) {Φ}_{21} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{12} ( {k}_{xa} , {k}_{{y}_{1}} , - {k}_{{η}_{2}} , k ) {Φ}_{12} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \text{.........} & ( 3 - 42 )\end{matrix}$$

The “+ . . . ” in (3-42) expresses terms corresponding to the fourth or higher order scattering, which may be omitted. By rearranging (3-42), (3-43) below is obtained.

$$\begin{matrix}[ Math . 89 ] & \\ {a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{( 2 π )} \text{} \int \int \int {Φ}_{11} ( {k}_{{x}_{a}} , {k}_{{y}_{1}} , {k}_{η} , k ) {Φ}_{21} ( {k}_{{x}_{b}} , - {k}_{η} , {k}_{{y}_{2}} , k ) δ ( \text{} {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int \{ {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{11} ( {k}_{xa} , {k}_{{y}_{1}} , - {k}_{{η}_{2}} , k ) {Φ}_{21} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{12} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \} \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} & ( 3 - 43 )\end{matrix}$$

In Equation (3-43), a₁ corresponds to the first-order scattering, second-order scattering, and third-order scattering. Specifically, a₁ is derived by removing the effects of second-order scattering and third-order scattering from the measurement data. A same procedure may be used to derive a₁ corresponding to the higher-order scattering. Moreover, a₂, a₃, and a₄ can also be derived by the same procedure. The general solution of the scattering field equation is expressed as shown in (3-44) below, using a₁.

$$\begin{matrix}[ Math . 90 ] & \\ {ϕ}_{1} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} & ( 3 - 44 )\end{matrix}$$

The imaging function ρ(x, y, z) is expressed as shown in (3-45) below, using φ₁ in (3-44) above.

$$\begin{matrix}[ Math . 91 ] & \\ ρ ( x , y , z ) = {Lim}_{t \to 0} [ \frac{1}{2 π} {{\int }_{- ∞}}^{∞} {ϕ}_{1} ( x , y , y , z , z , k ) {e}^{- icld} dk ] & ( 3 - 45 )\end{matrix}$$

The imaging function is a function from which the effects of multiple scattering have been removed, and which gives an explicit solution to the inverse scattering problem in the non-linear case.

Equation (3-41) may be generalized as shown in (3-46) below. Equation (3-46) may then be used as Equation (3-41).

$$\begin{matrix}[ Math . 92 ] & \\ {{Φ}_{ij}}_{i , j = 1 , 2} = {{a}_{{m}_{1}}}_{{m}_{1} = 1 , 2 , 3 , 4} + \frac{1}{{( 2 π )}^{1}} \int {f}_{2} {[ {a}_{{m}_{1}} {a}_{{m}_{2}} ]}_{{m}_{1} , {m}_{2} = 1 , 2 , 3 , 4} d {𝕜}_{{f}_{2}} + \frac{1}{{( 2 π )}^{2}} \int {f}_{3} {[ {a}_{{m}_{1}} {a}_{{m}_{2}} {a}_{{m}_{3}} ]}_{{m}_{1} , {m}_{2} , {m}_{3} = 1 , 2 , 3 , 4} d {𝕜}_{{f}_{3}} + … + \frac{1}{{( 2 π )}^{L - 1}} \int {f}_{L} {[ {a}_{{m}_{1}} {a}_{{m}_{2}} {a}_{{m}_{3}} … {a}_{{m}_{L}} ]}_{{m}_{1} , {m}_{2} , {m}_{3} , … , {m}_{L} = 1 , 2 , 3 , 4} d {𝕜}_{{f}_{L}} & ( 3 - 46 )\end{matrix}$$

Here, a₁, a₂, a₃, and a₄ expressed by aₘ₁, aₘ₂, aₘ₃, . . . , a_{mL}, correspond to the a(kₓ, k_{y1}, k_{y2}, k) in the analytical solution related to the four scattering states. Moreover, f₂, f₃, . . . , f_{L} are the products of 2, 3, . . . , L variables in the square brackets corresponding to 2, 3, . . . , L scattering, respectively.

Moreover,

$${𝕜}_{{f}_{2}} , {𝕜}_{{f}_{3}} , … , {𝕜}_{{f}_{L}} \qquad [ Math . 93 ]$$

denote the wave number vectors related to the coordinate variables included in 2, 3, . . . , L variables in the square brackets of f₂, f₃, . . . , f_{L}.

Moreover, Equation (3-42) may be generalized as shown in (3-47) below, and (3-47) may be used as (3-42).

$$\begin{matrix}[ Math . 94 ] & \\ {{a}_{m}}_{m = 1 , 2 , 3 , 4} = {{Φ}_{ij}}_{ij = 1 , 2} - \frac{1}{{( 2 π )}^{1}} \int {g}_{2} {{[ {Φ}_{{m}_{1} {n}_{1}} {Φ}_{{m}_{2} {n}_{2}} ]}_{{m}_{1} , {n}_{1} = 1 , 2}}_{{m}_{2} , {n}_{2} = 1 , 2} d {𝕜}_{{g}_{2}} - \frac{1}{{( 2 π )}^{2}} \int {g}_{3} {{{[ {Φ}_{{m}_{1} {n}_{1}} {Φ}_{{m}_{2} {n}_{2}} {Φ}_{{m}_{3} {n}_{3}} ]}_{{m}_{1} , {n}_{1} = 1 , 2}}_{{m}_{2} , {n}_{2} = 1 , 2}}_{{m}_{3} , {n}_{3} = 1 , 2} d {𝕜}_{{g}_{3}} - … - \frac{1}{{( 2 π )}^{L - 1}} \int {g}_{L} {{{{{[ {Φ}_{{m}_{1} {n}_{1}} {Φ}_{{m}_{2} {n}_{2}} {Φ}_{{m}_{3} {n}_{3}} … {Φ}_{{m}_{L} {n}_{L}} ] d {𝕜}_{{g}_{L}}}_{{m}_{1} , {n}_{1} = 1 , 2}}_{{m}_{2} , {n}_{2} = 1 , 2}}_{{m}_{3} , {n}_{3} = 1 , 2}}_{…}}_{{m}_{L} , {n}_{L} = 1 , 2} & ( 3 - 47 )\end{matrix}$$

Here, a₁, a₂, a₃, and a₄ expressed by am correspond to a(kₓ, k_{y1}, k_{y2}, k) in the analytical solution related to the four scattering states. Moreover, Φ₁₁, Φ₁₂, Φ₂₁, and Φ₂₂, expressed by Φₘ₁ₙ₁, Φₘ₂ₙ₂, Φₘ₃ₙ₃, . . . , Φ_{mLnL}, correspond to the measurement data related to the four scattering states. Moreover, g₂, g₃, . . . , g_{L} are the products of 2, 3, . . . , L variables in the square brackets corresponding to 2, 3, . . . , L scattering applied from wave transmission to wave reception, respectively.

Moreover,

$${𝕜}_{{g}_{2}} , {𝕜}_{{g}_{3}} , … , {𝕜}_{{g}_{L}} \qquad [ Math . 95 ]$$

denote the wave number vectors related to the coordinate variables included in 2, 3, . . . , L variables in the square brackets of g₂, g₃, . . . , g_{L}.

The scattering field function may be generalized as shown in (3-48) below.

$$\begin{matrix}[ Math . 96 ] & \\ {ϕ}_{m} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x - {k}_{{y}_{1}} {y}_{1} + {k}_{{y}_{2}} {y}_{2} )} {a}_{m} ( {k}_{x} , {k}_{{y}_{1}} , {k}_{{y}_{2}} , k ) \cdot {e}^{i {s}_{1} ( {k}_{x} , {k}_{{y}_{1}} , {k}_{{y}_{2}} ) {z}_{1}} {e}^{i {s}_{2} ( {k}_{x} , {k}_{{y}_{1}} , {k}_{{y}_{2}} ) {z}_{2}} {dk}_{x} {dk}_{{y}_{1}} {dk}_{{y}_{2}} & ( 3 - 48 )\end{matrix}$$

$$m = 1 , 2 , 3 , 4$$

The imaging function may be generalized as shown in (3-49) below.

$$\begin{matrix}[ Math . 97 ] & \\ ρ ( x , y , z ) = {Lim}_{t \to 0} [ \frac{1}{2 π} {{\int }_{- ∞}}^{∞} {ϕ}_{m} ( x , y , y , z , z , k ) {e}^{- ickt} dk ] & ( 3 - 49 )\end{matrix}$$

### <IV Configuration and Operation of Imaging Device>

Based on the above description, a configuration and operation of an imaging device that uses waves to visualize the three-dimensional structure of each scatterer included in an object in a region will be described below.

Here, waves are, for example, radio waves, and may be microwaves, millimeter waves, terahertz waves, and the like. Moreover, light, sound, or the like may be used as the waves. The object in the region may be a living body, a manufactured object, or a natural material. In particular, the imaging device may be used for mammography, and the object may be a breast.

Moreover, each scatterer included in an object in a region corresponds to a portion that has physical properties different from those of the surrounding medium. Specifically, this physical property corresponds to the wave reflectance. When radio waves are used as waves, the physical property may be dielectric constant. The scatterer included in the object may be a rebar in reinforced concrete or a tumor in a breast. The region to be measured may be equivalent to the region of the object.

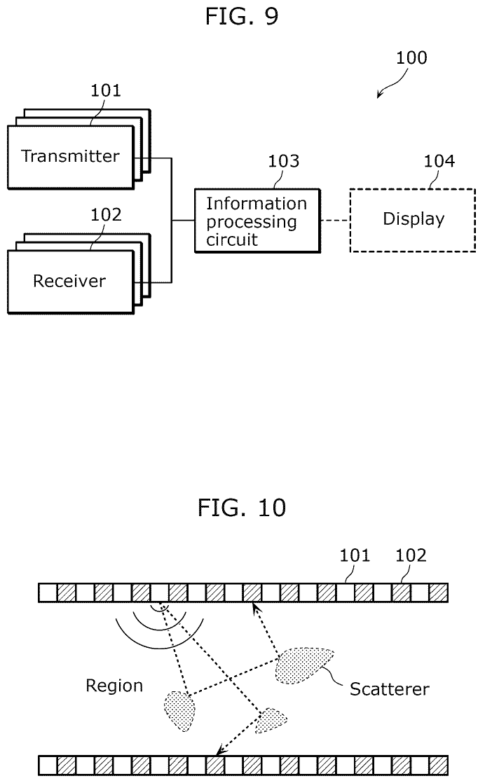

FIG. 9 illustrates a basic configuration of the imaging device according to the present embodiment. Imaging device 100 illustrated in FIG. 9 includes a plurality of transmitters 101, a plurality of receivers 102, and information processing circuit 103. Imaging device 100 may also include display 104.

Each of transmitters 101 is a circuit that transmits a wave. Specifically, transmitters 101 sequentially transmit waves. Transmitters 101 are arranged on both sides of the region to be measured.

Each of receivers 102 is a circuit that receives the wave. Receivers 102 may receive waves simultaneously and in parallel. In a similar manner to transmitters 101, receivers 102 are arranged on both sides of the region to be measured. Receivers 102 may be located in substantially the same position as transmitters 101 or in the positions different from transmitters 101.

Transmitters 101 and receivers 102 may form a multistatic antenna or a monostatic antenna.

Information processing circuit 103 is a circuit that processes information, Specifically, information processing circuit 103 visualizes the three-dimensional structure of each scatterer included in an object in a region based on the measurement data obtained by transmitters 101 and receivers 102. For example, information processing circuit 103 performs the arithmetic processing shown in the theories described above when visualizing the three-dimensional structure of the scatterer based on the measurement data.

Information processing circuit 103 may be a computer or a computer processor. Information processing circuit 103 may perform information processing by reading a program from memory and executing the program. Information processing circuit 103 may also be a dedicated circuit that visualizes the three-dimensional structure of the scatterer based on the measurement data.

In addition, information processing circuit 103 may generate an image indicating the three-dimensional structure of the scatterer in order to visualize the three-dimensional structure of the scatterer.

Information processing circuit 103 may visualize the three-dimensional structure of the scatterer by outputting the image indicating the three-dimensional structure of the scatterer to display 104 or the like. Alternatively, information processing circuit 103 may visualize the three-dimensional structure of the scatterer by outputting the image indicating the three-dimensional structure of the scatterer to a printer (not illustrated). Alternatively, information processing circuit 103 may visualize the three-dimensional structure of the scatterer by transmitting the image as electronic data to another device (not illustrated) through wired or wireless communication.

Display 104 is a display device, such as a liquid crystal display. Note that display 104 is an optional structural element, but not an essential structural element. Display 104 may also be an external device that does not form imaging device 100.

FIG. 10 is a conceptual diagram illustrating an example of a relation between transmitters 101, receivers 102, and a region. As illustrated in FIG. 10, transmitters 101 are arranged on both sides of the region to be measured. Similarly, receivers 102 are arranged on both sides of the region to be measured. Transmitters 101 and receivers 102 may be arranged two-dimensionally on each of the two measurement surfaces. Alternatively, by causing transmitter 101 and receiver 102 arranged on the two measurement surfaces to move, transmission at a plurality of transmission positions and reception at a plurality of reception positions may be performed.

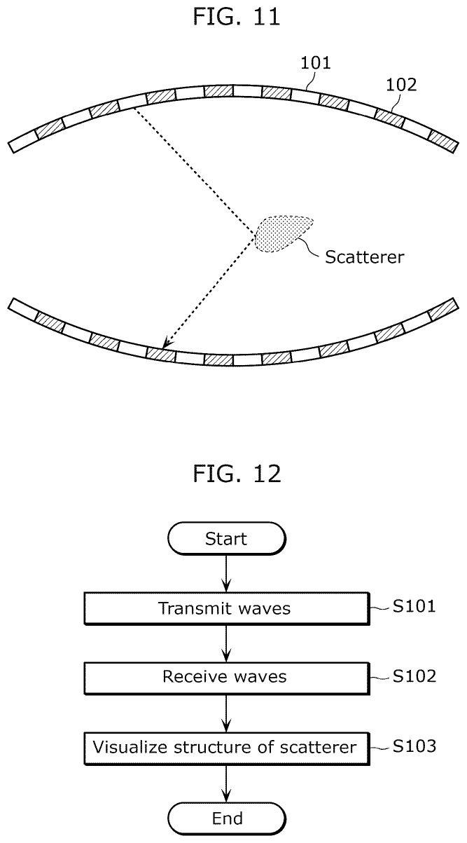

FIG. 11 is a conceptual diagram illustrating a variation of the relation between transmitters 101, receivers 102, and the region. As illustrated in FIG. 11, transmitters 101 and receivers 102 may be arranged on curved surfaces on both sides of the region,

FIG. 12 is a flowchart illustrating a basic operation of imaging device 100 illustrated in FIG. 9. Specifically, transmitters 101, receivers 102, and information processing circuit 103 in imaging device 100 illustrated in FIG. 9 perform the operations illustrated in FIG. 10.

First, a plurality of transmitters 101 transmit waves to a region to be measured (S101). For example, transmitters 101 sequentially transmit waves. A plurality of receivers 102 receive waves from the region to be measured (S102). For example, receivers 102 receive waves in parallel. The received waves can also be referred to as scattered waves. Information processing circuit 103 then visualizes the three-dimensional structure of each of scatterers included in an object in a region based on the measurement data obtained by transmitters 101 and receivers 102 (S103).

Specifically, information processing circuit 103 derives an imaging function corresponding to the scattering field function related to the scattering of the waves according to the correspondence between the measurement data and a composition of a plurality of functions related to multiple first-order scattering that form multiple scattering. Information processing circuit 103 then visualizes the three-dimensional structure of the scatterer included in the object in the region, using the imaging function.

This allows imaging device 100 to apply the correspondence between the measurement data and the composition of a plurality of functions related to multiple first-order scattering to derive an imaging function for visualizing the three-dimensional structure of each scatterer included in an object in a region. Multiple scattering is assumed to be a combination of multiple first-order scattering.

Accordingly, imaging device 100 is capable of analytically solving the inverse problem of scattering, including multiple scattering, according to this correspondence. Hence, imaging device 100 is capable of visualizing, with high accuracy, the three-dimensional structure of each scatterer included in an object in a region.

For example, information processing circuit 103 may derive the imaging function corresponding to the scattering field function by solving the equation of the scattering field function based on the measurement data. Moreover, the scattering field function may be expressed by

$$ϕ ( x , {y}_{1} , {y}_{2} , {z}_{1} , {z}_{2} , k ) = \int {\int }_{D} \frac{{e}^{ik {ρ}_{1}}}{{ρ}_{1}} \frac{{e}^{ik {ρ}_{2}}}{{ρ}_{2}} ε ( ξ , η , ζ ) d ξ d η d ζ . \qquad [ Math . 98 ]$$

Here (x, y₁, z₁) denotes the transmission position of the wave, (x, _{y2}, z₂) denotes the reception position of the wave, k denotes the wave number of the wave, D denotes the region, (ξ, η, ζ) corresponds to the reflection position of the wave, and ϵ corresponds to an unknown reflectance at the reflection position. Moreover, ρ₁ denotes the distance from the transmission position to the reflection position, and ρ₂ denotes the distance from the reflection position to the reception position.

Moreover, the equation of the scattering field function may be expressed by

$$[ \frac{1}{4} {Δ}_{5}^{2} - \frac{1}{{c}^{2}} {\partial }_{t}^{2} {\partial }_{x}^{2} - ( {\partial }_{{y}_{1}}^{2} + {\partial }_{{z}_{1}}^{2} ) ( {\partial }_{{y}_{2}}^{2} + {\partial }_{{z}_{2}}^{2} ) ] ϕ = 0. \qquad [ Math . 99 ]$$

Here, Δₛ denotes the Laplace operator with respect to x, y₁, y₂, z₁, and z₂, c denotes the propagation velocity of the wave, and t denotes the time taken from the wave transmission to the wave reception,

This allows imaging device 100 to visualize, with high accuracy, the three-dimensional structure of each scatterer included in an object in a region, according to the scattering field function associated with the scattering phenomenon and the equation satisfied by the scattering field function.

For example, information processing circuit 103 may derive an analytical solution of the equation based on the measurement data. Information processing circuit 103 may then derive the imaging function based on the analytical solution. The analytical solution may be expressed by

$$ϕ ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} a ( {k}_{x} , {k}_{{y}_{1}} , {k}_{{y}_{2}} , k ) {e}^{i {s}_{1} ( {k}_{x} , {k}_{{y}_{1}} , {k}_{{y}_{2}} ) {z}_{1}} {e}^{i {s}_{2} ( {k}_{x} , {k}_{{y}_{1}} , {k}_{{y}_{2}} ) {z}_{2}} {dk}_{x} {dk}_{{y}_{1}} {dk}_{{y}_{2}} . \qquad [ Math . 100 ]$$

Here, kₓ, k_{y1}, and k_{y2} denote wave numbers related to x, y₁ and y₂ of the scattering field function. Moreover, a(kₓ, k_{y1}, k_{y2}, k) denotes a function based on kₓ, k_{y1}, k_{y2} and k, s₁(kₓ, k_{y1}, k_{y2}) denotes a function based on kₓ, k_{y1} and k_{y2}, and s₂(kₓ, k_{y1}, k_{y2}) denotes a function based on kₓ, k_{y1}, and k_{y2}.

This allows imaging device 100 to visualize, with high accuracy, the three-dimensional structure of each scatterer included in an object in a region according to the analytical solution of the equation satisfied by the scattering field function associated with the scattering phenomenon.

For example, the imaging function may be expressed by

$$ρ ( x , y , z ) = {Lim}_{t \to 0} [ \frac{1}{2 π} {{\int }_{- ∞}}^{∞} ϕ ( x , y , y , z , z , k ) {e}^{- ickt} dk ] . \qquad [ Math . 101 ]$$

Here, (x, y, z) denotes the position of an imaging target.

This allows imaging device 100 to visualize, with high accuracy, the three-dimensional structure of each scatterer included in an object in a region according to the imaging function appropriately associated with the scattering field function.

Moreover, for example, multiple scattering may be expressed using four functions of a spectral space corresponding to the four fundamental solutions of the scattering field function equation. Additionally, the relation between the measurement data and the four functions may be expressed by a nonlinear integral equation. Information processing circuit 103 may then derive four functions from the measured data according to the nonlinear integral equation. Information processing circuit 103 may then use the four functions to derive the imaging function corresponding to the scattering field function.

This allows imaging device 100 to visualize, with high accuracy, the three-dimensional structure of each scatterer included in an object in a region according to relational expression that expresses multiple scattering.

For example, the measurement data may be expressed by

$${{Φ}_{ij}}_{i , j = 1 , 2} \qquad [ Math . 102 ]$$

Here, Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions.

Information processing circuit 103 then uses

$${{Φ}_{ij}}_{i , j = 1 , 2} = {{a}_{{m}_{1}}}_{{m}_{1} = 1 , 2 , 3 , 4} + \frac{1}{{( 2 π )}^{1}} \int {f}_{2} {[ {a}_{{m}_{1}} {a}_{{m}_{2}} ]}_{{m}_{1} , {m}_{2} = 1 , 2 , 3 , 4} d {𝕜}_{{f}_{2}} + \frac{1}{{( 2 π )}^{2}} \int {f}_{3} {[ {a}_{{m}_{1}} {a}_{{m}_{2}} {a}_{{m}_{3}} ]}_{{m}_{1} , {m}_{2} , {m}_{3} = 1 , 2 , 3 , 4} d {𝕜}_{{f}_{1}} + … + \frac{1}{{( 2 π )}^{L - 1}} \int {f}_{L} {[ {a}_{{m}_{1}} {a}_{{m}_{2}} {a}_{{m}_{3}} … {a}_{{m}_{L}} ]}_{{m}_{1} , {m}_{2} , {m}_{3} , … , {m}_{L} = 1 , 2 , 3 , 4} d {𝕜}_{{f}_{L}} to derive , \qquad [ Math . 103 ]$$

$${{a}_{{m}_{1}}}_{{m}_{1} = 1 , 2 , 3 , 4} \qquad [ Math . 104 ]$$

from which the effects of multiple scattering have been removed.

Here, a₁, a₂, a₃, and a₄ expressed by aₘ₁, aₘ₂, aₘ₃, . . . , a_{mL}, correspond to a(kₓ, k_{y1}, k_{y2}, k) in the analytical solution related to the four scattering states. Moreover, f₂, f₃, . . . , f_{L} denote the products of 2, 3, . . . , L variables in the square brackets corresponding to 2, 3, . . . , L scattering applied from wave transmission to wave reception, respectively.

$${𝕜}_{{f}_{2}} , {𝕜}_{{f}_{3}} , … , {𝕜}_{{f}_{L}} \qquad [ Math . 105 ]$$

denote the wave number vectors related to the coordinate variables included in 2, 3, . . . , L variables in the square brackets of f₂, f₃, . . . , f_{L}.

Information processing circuit 103 may then use, as a scattering field function,

$${ϕ}_{{m}_{1}} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{{m}_{1}} ( {k}_{x} , {k}_{{y}_{1}} , {k}_{{y}_{2}} , k ) \cdot {e}^{i {s}_{1} ( {k}_{x} , {k}_{{y}_{1}} , {k}_{{y}_{2}} ) {z}_{1}} {e}^{i {s}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 106 ]$$

$${m}_{1} = 1 , 2 , 3 , 4$$

to derive, as an imaging function,

$$ρ ( x , y , z ) = {Lim}_{t \to 0} [ \frac{1}{2 π} {{\int }_{- ∞}}^{∞} {ϕ}_{{m}_{1}} ( x , y , y , z , z , k ) {e}^{- ickt} dk ] . \qquad [ Math . 107 ]$$

This allows imaging device 100 to visualize, with high accuracy, the three-dimensional structure of each scatterer included in an object in a region according to the equation based on the multiple scattering theory.

For example, the measurement data is expressed by

$${{Φ}_{ij}}_{i , j = 1 , 2} \qquad [ Math . 108 ]$$

Here, Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions.

Information processing circuit 103 may then use

$${{a}_{m}}_{m = 1 , 2 , 3 , 4} = {{Φ}_{ij}}_{ij = 1 , 2} - \frac{1}{{( 2 π )}^{1}} \int {g}_{2} [ {{Φ}_{{m}_{1} {n}_{1}} {Φ}_{{m}_{2} {n}_{2}}}_{\begin{matrix}{m}_{1} , {n}_{1} = 1 , 2 \\ {m}_{2} , {n}_{2} = 1 , 2\end{matrix}} ] d {𝕜}_{{g}_{2}} - \frac{1}{{( 2 π )}^{2}} \int {g}_{3} [ {{Φ}_{{m}_{1} {n}_{1}} {Φ}_{{m}_{2} {n}_{2}} {Φ}_{{m}_{3} {n}_{3}}}_{\begin{matrix}{m}_{1} , {n}_{1} = 1 , 2 \\ {m}_{2} , {n}_{2} = 1 , 2 \\ {m}_{3} , {n}_{3} = 1 , 2\end{matrix}} ] d {𝕜}_{{g}_{3}} - … - \frac{1}{{( 2 π )}^{L - 1}} \int {g}_{L} [ {{Φ}_{{m}_{1} {n}_{1}} {Φ}_{{m}_{2} {n}_{2}} {Φ}_{{m}_{3} {n}_{3}} … {Φ}_{{m}_{L} {n}_{L}}}_{\begin{matrix}{m}_{1} , {n}_{1} = 1 , 2 \\ {m}_{2} , {n}_{2} = 1 , 2 \\ \begin{matrix}{m}_{3} , {n}_{3} = 1 , 2 \\ … \\ {m}_{L} , {n}_{L} = 1 , 2\end{matrix}\end{matrix}} ] d {𝕜}_{{g}_{L}} \qquad [ Math . 109 ]$$

to derive

$${{a}_{m}}_{m = 1 , 2 , 3 , 4} \qquad [ Math . 110 ]$$

from which the effects of multiple scattering has been removed.

Here a₁, a₂, a₃, and a₄, expressed by aₘ correspond to a(kₓ, k_{y1}, k_{y2}, k) in the analytical solution related to the four scattering states. Moreover, Φ₁₁, Φ₁₂, Φ₂₁, and Φ₂₂, expressed by Φₘ₁ₙ₁, Φₘ₂ₙ₂, Φₘ₃ₙ₃, . . . , Φ_{mLnL}, correspond to the measurement data related to the four scattering states. Moreover, g₂, g₃, . . . , g_{L} denote the products of 2, 3, . . . , L variables in the square brackets corresponding to 2, 3, . . . , L scattering applied from wave transmission to wave reception, respectively.

Moreover,

$${𝕜}_{{g}_{2}} , {𝕜}_{{g}_{3}} , … , {𝕜}_{{g}_{L}} \qquad [ Math . 111 ]$$

denote wave number vectors related to the coordinate variables included in 2, 3, . . . , L variables in the square brackets of g₂, g₃, . . . , g_{L}.

Information processing circuit 103 then may use, as a scattering field function,

$${ϕ}_{m} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{m} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 112 ]$$

$$m = 1 , 2 , 3 , 4$$

to derive, as an imaging function,

$$ρ ( x , y , z ) = {Lim}_{i \to 0} [ \frac{1}{2 π} {\int }_{- ∞}^{∞} {ϕ}_{m} ( x , y , y , z , z , k ) {e}^{icki} dk ] . \qquad [ Math . 113 ]$$

This allows imaging device 100 to visualize, with high accuracy, the three-dimensional structure of each scatterer included in an object in a region according to the equation in which the measurement data is properly associated based on the multiple scattering theory.

For example, the measurement data is expressed by

$${{Φ}_{i j}}_{i , j = 1 , 2} \qquad [ Math . 114 ]$$

Here, Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions.

Information processing circuit 103 may then derive a₁ from which the effects of multiple scattering have been removed, using

$${Φ}_{11} ( {k}_{x} , {k}_{{y}_{1}} , {k}_{{y}_{2}} , k ) = {a}_{1} ( {k}_{x} , {k}_{{y}_{1}} , {k}_{{y}_{2}} , k ) + \frac{1}{2 π} \int \int \int {a}_{1} ( {k}_{{x}_{a}} , {k}_{{y}_{1}} , {k}_{η} , k ) {a}_{4} ( {k}_{{x}_{b}} , {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , {k}_{η} , {k}_{{y}_{3}} ) ) {dk}_{{x}_{a}} {dk}_{{x}_{b}} {dk}_{η} + \frac{1}{{( 2 π )}^{2}} \int \int \int \int \int {a}_{1} ( {k}_{xa} , {k}_{{y}_{1}} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , - {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{1} ( {k}_{xb} , {k}_{{η}_{2}} , - {k}_{{η}_{3}} , k ) {a}_{4} ( {k}_{xc} , {k}_{{η}_{3}} , - {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{1} ( {k}_{xa} , {k}_{{y}_{1}} , - {k}_{{η}_{2}} , k ) {a}_{4} ( {k}_{xb} , {k}_{{η}_{2}} , - {k}_{{η}_{3}} , k ) {a}_{4} ( {k}_{xc} , {k}_{{η}_{3}} , - {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{3} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} + O ( {a}^{4} ) . \qquad [ Math . 115 ]$$

Here, δ denotes a delta function, kₓₐ, k_{xb}, and k_{xc} are variables corresponding to kₓ, k_{η} and k_{η2} are variables corresponding to k_{y1}, k_{η3} is a variable corresponding to k_{y2}, and O(a⁴) is a term corresponding to fourth or higher order scattering.

Information processing circuit 103 may then use, as a scattering field function,

$${ϕ}_{1} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 116 ]$$

to derive, as an imaging function,

$$ρ ( x , y , z ) = {Lim}_{i \to 0} [ \frac{1}{2 π} {\int }_{- ∞}^{∞} {ϕ}_{1} ( x , y , y , z , z , k ) {e}^{- icki} dk ] . \qquad [ Math . 117 ]$$

This allows imaging device 100 to visualize, with high accuracy, the three-dimensional structure of each scatterer included in an object in a region according to the equation in which the scattering phenomenon is concretely expressed based on the multiple scattering theory.

For example, the measurement data is expressed by

$${{Φ}_{i j}}_{i , j = 1 , 2} \qquad [ Math . 118 ]$$

Here, Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions.

Information processing circuit 103 may derive a₁ from which the effects of multiple scattering have been removed, using

$${a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{2 π} \int \int \int {Φ}_{11} ( {k}_{{x}_{a}} , {k}_{{y}_{1}} , {k}_{η} , k ) {Φ}_{21} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{11} ( {k}_{xa} , {k}_{{y}_{1}} , - {k}_{{η}_{2}} , k ) {Φ}_{21} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( \text{} {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{12} ( {k}_{xa} , {k}_{{y}_{1}} , - {k}_{{η}_{2}} , k ) {Φ}_{12} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} + {k}_{{y}_{1}} - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} . \qquad [ Math . 119 ]$$

Here, δ denotes a delta function, kₓₐ, k_{xb}, and k_{xc} are variables corresponding to kₓ, k_{η} and k_{η2} are variables corresponding to k_{y1}, and k_{η3} is a variable corresponding to k_{y2}.

Information processing circuit 103 may then use, as a scattering field function,

$${ϕ}_{1} ( x , {y}_{1} , {y}_{2} , {z}_{1} , {z}_{2} , k ) = \frac{1}{{( 2 π )}^{3}} {\int }_{- ∞}^{∞} {\int }_{- ∞}^{∞} {\int }_{- ∞}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 120 ]$$

to derive, as an imaging function,

$$ρ ( x , y , z ) = {Lim}_{i \to 0} [ \frac{1}{2 π} {\int }_{- ∞}^{∞} {ϕ}_{1} ( x , y , y , z , z , k ) {e}^{- icki} dk ] . \qquad [ Math . 121 ]$$

This allows imaging device 100 to visualize, with high accuracy, the three-dimensional structure of each scatterer included in an object in a region according to the equation in which the scattering phenomenon is concretely expressed based on the multiple scattering theory and the measurement data is properly associated. For example, the measurement data is expressed by

$${{Φ}_{i j}}_{i , j = 1 , 2} . \qquad [ Math . 122 ]$$

Here, Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions.

Information processing circuit 103 may then derive a₁ from which the effects of multiple scattering have been removed, using

$${a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{2 π} \int \int \int {Φ}_{11} ( {k}_{{x}_{a}} , {k}_{{y}_{1}} , {k}_{η} , k ) {Φ}_{21} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{xb} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int \{ {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( \text{} {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{11} ( {k}_{xa} , {k}_{{y}_{1}} , - {k}_{{η}_{2}} , k ) {Φ}_{21} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{12} ( \text{} {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \} \cdot δ ( \text{} {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xc} , {k}_{{η}_{3}} , {k}_{{y}_{2}} ) ) {dk}_{xa} {dk}_{xb} {dk}_{xc} {dk}_{{η}_{2}} {dk}_{{η}_{3}} . \qquad [ Math . 123 ]$$

Here, δ denotes a delta function, kₓₐ, k_{xb}, and k_{xc} are variables corresponding to kₓ, k_{η} and k_{η2} are variables corresponding to k_{y1}, and k_{η3} is a variable corresponding to k_{y2}.

Information processing circuit 103 may then use, as a scattering field function,

$${ϕ}_{1} ( x , {y}_{1} , {y}_{2} , {z}_{1} , {z}_{2} , k ) = \frac{1}{{( 2 π )}^{3}} {\int }_{- ∞}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 124 ]$$

to derive, as an imaging function,

$$ρ ( x , y , z ) = {Lim}_{t \to 0} [ \frac{1}{2 π} {{\int }^{∞}}_{- ∞} {ϕ}_{1} ( x , y , y , z , z , k ) {e}^{- ickt} dk ] . \qquad [ Math . 125 ]$$

This allows imaging device 100 to visualize, with high accuracy, the three-dimensional structure of a scatterer included in an object in a region according to the equations rearranged based on the multiple scattering theory.

For example, the scattering field function may be defined as a function in which the transmission position of the wave and the reception position of the wave are input and a value indicating the wave at the reception position is output. The imaging function may be defined based on the value output from the scattering field function by inputting the position of an imaging target as the transmission position and the reception position to the scattering field function. Information processing circuit 103 may use the measurement data as a boundary condition to derive a scattering field function, and may use the scattering field function to derive an imaging function.

For example, other structural elements, equations, expressions, variables, and the like described in the present embodiment may be appropriately applied to transmitters 101, receivers 102, information processing circuit 103, the scattering field functions, the imaging functions and the like described in the basic configuration and basic operation above.

The scattering field functions, imaging functions, and the like indicated in the present embodiment may be applied with modifications as appropriate. For example, other formulas that include substantially the same content as the formulas described above may be used, and other formulas that are derived based on the theories described above may be used.

In the description above, the expression of the fundamental solution and the expression of the analytical solution may be read interchangeably.

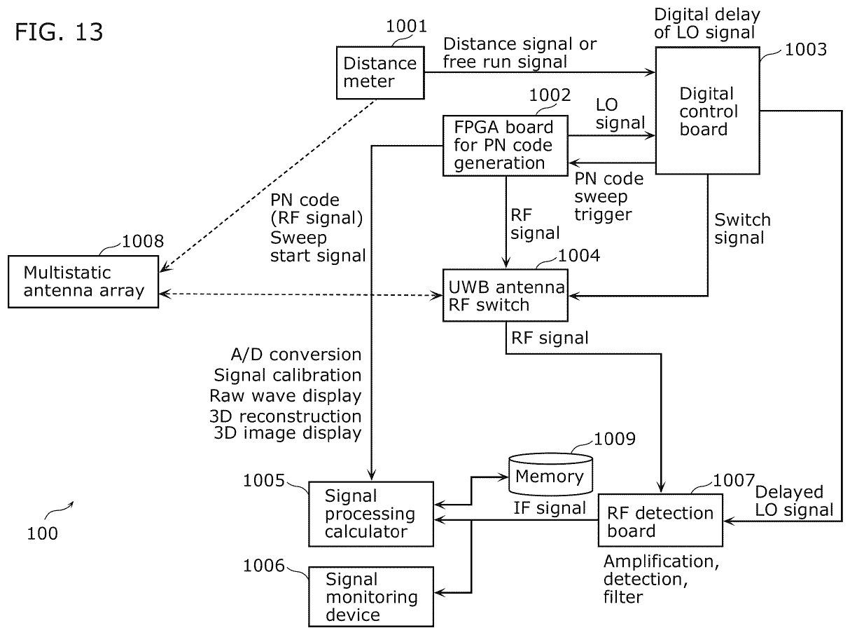

FIG. 13 is a block diagram illustrating a specific configuration of imaging device 100 illustrated in FIG. 9.

Transmitters 101 and receivers 102 in imaging device 100 illustrated in FIG. 9 may be included in multistatic antenna array 1008. Information processing circuit 103 in imaging device 100 illustrated in FIG. 9 may correspond to one or more of the structural elements illustrated in FIG. 13. Specifically, for example, information processing circuit 103 may correspond to signal processing calculator 1005. Display 104 illustrated in FIG. 9 may correspond to signal monitoring device 1006.

The microwave signal used in imaging device 100 is a pseudo-random time-series signal (pseudo noise code (PN code)) with a frequency component of DC to 20 GHz. This signal is output from FPGA board 1002 for PN code generation. More specifically, the signal is classified into two types. One type of the signal (local oscillator signal (LO signal)) is transmitted to an RF detection circuit (RF detection board 1007) via a delay circuit (digital control board 1003).

The other type of the signal (radio frequency (RF) signal) is transmitted to and radiated from a transmitting microwave UWB antenna of multistatic antenna array 1008. The scattered microwave signal is received by the UWB antenna for reception of multistatic antenna array 1008 and transmitted to the RF detection circuit (RF detection board 1007). Here, the transmitted and received signals pass through an antenna element selection switch (UWB antenna RF switch 1004).

The signal to be delayed (LO signal) is delayed by ½ⁿ times (n is an integer greater than 2) the amount of time it takes for the PN code value to change. The detected signal undergoes analog-to-digital (AD) conversion performed by signal processing calculator 1005 and is stored as an intermediate frequency (IF) signal. Moreover, information indicating the detected signal may be displayed on signal monitoring device 1006.

The timing of these series of operations is controlled by the microcontroller in digital control board 1003 in synchronization with the signal (distance signal or free run signal) from distance meter 1001. For example, the microprocessor in digital control board 1003 transmits a switch signal, a PN code sweep trigger, and the like.

Moreover, signal processing calculator 1005 performs three-dimensional reconstruction using the stored signals after the AD conversion, and displays a three-dimensional image. Signal processing calculator 1005 may also perform signal calibration. Signal processing calculator 1005 may also perform raw wave display. For example, signal processing calculator 1005 may store a three-dimensional image, and the like in memory 1009.

The configuration illustrated in FIG. 13 is an example, and the configuration of imaging device 100 is not limited to the configuration illustrated in FIG. 13. The configuration illustrated in FIG. 13 may be partially omitted or changed.

### (Supplemental Information)

Although the aspects of the imaging device have been described above based on the embodiment, the aspects of the imaging device are not limited to such an embodiment. Various modifications conceivable by those skilled in the art may be made to the embodiment, and a plurality of structural elements in the embodiment may be combined arbitrarily. For example, a process executed by a specific structural element in the embodiment may be executed by a different structural element instead. Moreover, the processing order of the processes may be changed, and the processes may be performed in parallel.

An imaging method including steps performed by the structural elements included in the imaging device may be executed by an arbitrary device or system. For example, part or all of the imaging method may be executed by a computer including, for example, a processor, memory, and an input and output circuit. In such cases, the imaging method may be executed by a program for causing a computer to execute the imaging method being executed by the computer.

The program may be recorded on a non-transitory computer-readable recording medium.

Each of the structural elements of the imaging device may be configured in the form of dedicated hardware, in the form of general-purpose hardware that executes the above program or the like, or any combination thereof. Moreover, the general-purpose hardware may be configured in the form of memory on which a program is recorded and a general-purpose processor that reads the program from the memory and executes the program. Here, the memory may be semiconductor memory or a hard disk, and the general-purpose processor may be a central processing unit (CPU) or the like.

The dedicated hardware may be configured in the form of memory and a dedicated processor or the like. For example, the dedicated processor may reference the memory for recording the measurement data and execute the imaging method described above.

Each of the structural elements of the imaging device may be an electrical circuit. The electrical circuits may collectively form a single electrical circuit and, alternatively, may form individual electrical circuits. These electrical circuits may correspond to dedicated hardware or general-purpose hardware that executes the above program, for example.

### INDUSTRIAL APPLICABILITY

One aspect of the present disclosure is useful for an imaging device that uses waves to visualize the three-dimensional structure of each scatterer in an object in a region, and is applicable to, for example, geophysical exploration or medical diagnosis.

### REFERENCE SIGNS LIST

100 imaging device
101 transmitter
102 receiver
103 information processing circuit
104 display
1001 distance meter
1002 FPGA board for PN code generation
1003 digital control board
1004 UWB antenna RF switch
1005 signal processing calculator
1006 signal monitoring device
1007 RF detection board
1008 multistatic antenna array
1009 memory

1. An imaging device comprising:
a plurality of transmitters which are disposed on both sides of a region to be measured, and each of which transmits a wave to the region;
a plurality of receivers which are disposed on the both sides, and each of which receives the wave; and
an information processing circuit which derives an imaging function corresponding to a scattering field function related to scattering of the wave according to a correspondence between (i) measurement data obtained by the plurality of transmitters and the plurality of receivers and (ii) a composition of a plurality of functions related to multiple first-order scattering forming multiple scattering, and visualizes a three-dimensional structure of a scatterer included in an object in the region, using the imaging function,

2. The imaging device according to claim 1,
wherein the information processing circuit derives the imaging function corresponding to the scattering field function by solving an equation of the scattering field function based on the measurement data,
the scattering field function is expressed by
$$ϕ ( x , {y}_{1} , {y}_{2} , {z}_{1} , {z}_{2} , k ) = {\int \int }_{D} \frac{{e}^{ik {ρ}_{1}}}{{ρ}_{1}} \frac{{e}^{ik {ρ}_{2}}}{{ρ}_{2}} ε ( ξ , η , ζ ) d ξ d η d ζ \qquad [ Math . 1 ]$$
where (x, y₁, z₁) denotes a transmission position of the wave, (x, y₂, z₂) denotes a reception position of the wave, k denotes a wave number of the wave, D denotes the region, (ξ, η, ζ) corresponds to a reflection position of the wave, ϵ corresponds to an unknown reflectance at the reflection position, ρ₁ denotes a distance from the transmission position to the reflection position, and ρ₂ denotes a distance from the reflection position to the reception position, and
the equation is expressed by
$$[ \frac{1}{4} {Δ}_{s}^{2} - \frac{1}{{c}^{2}} {\partial }_{t}^{2} {\partial }_{x}^{2} - ( {\partial }_{{y}_{1}}^{2} + {\partial }_{{z}_{1}}^{2} ) ( {\partial }_{{y}_{2}}^{2} + {\partial }_{{z}_{2}}^{2} ) ] ϕ = 0 \qquad [ Math . 2 ]$$
where Δ₅ denotes a Laplace operator related to x, y₁, y₂, z₁, and z₂, c denotes a propagation velocity of the wave, and t denotes a time taken from transmission of the wave to reception of the wave.

3. The imaging device according to claim 2,
wherein the information processing circuit derives an analytical solution of the equation based on the measurement data, and derives the imaging function based on the analytical solution, and
the analytical solution is expressed by
$${ϕ}_{1} ( x , {y}_{1} , {y}_{2} , {z}_{1} , {z}_{2} , k ) = \frac{1}{{( 2 π )}^{3}} {\int }_{- ∞}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} a ( {k}_{x} , {k}_{{y}_{1}} , {k}_{{y}_{2}} , k ) {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 3 ]$$
where kₓ, k_{y1}, and k_{y2} denote wave numbers related to x, y₁, and y₂ of the scattering field function, a(kₓ, k_{y1}, k_{y2}, k) denotes a function based on kₓ, k_{y1}, k_{y2}, and k, s₁(kₓ, k_{y1}, k_{y2}) denotes a function based on kₓ, k_{y1}, and k_{y2}, and s₂(kₓ, k_{y1}, k_{y2}) denotes a function based on kₓ, k_{y1}, and k_{y2}.

4. The imaging device according to claim 3,
wherein the information processing circuit derives the imaging function based on the analytical solution, and
the imaging function is expressed by
$$ρ ( x , y , z ) = {Lim}_{t \to 0} [ \frac{1}{2 π} {{\int }^{∞}}_{- ∞} {ϕ}_{1} ( x , y , y , z , z , k ) {e}^{- ickt} dk ] \qquad [ Math . 4 ]$$
where (x, y, z) denotes a position of an imaging target.

5. The imaging device according to claim 1,
wherein the multiple scattering is expressed using four functions of a spectral space corresponding to four fundamental solutions of an equation of the scattering field function,
a relation between the measurement data and the four functions is expressed by a non-linear integral equation, and
the information processing circuit:
derives the four functions from the measurement data according to the non-linear integral equation; and
derives the imaging function corresponding to the scattering field function, using the four functions.

6. The imaging device according to claim 4,
wherein the measurement data is expressed by
$${{Φ}_{ij}}_{i , j = 1 , 2} \qquad [ Math . 5 ]$$
where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions,
the information processing circuit uses
$${{Φ}_{ij}}_{i , j = 1 , 2} = {{a}_{{m}_{1}}}_{{m}_{1} = 1 , 2 , 3 , 4} + \frac{1}{{( 2 π )}^{1}} \int {f}_{2} {[ {α}_{{m}_{1}} {a}_{{m}_{2}} ]}_{{m}_{1} , {m}_{2} = 1 , 2 , 3 , 4} d {𝕜}_{{f}_{2}} + \frac{1}{{( 2 π )}^{2}} \int {f}_{3} {[ {α}_{{m}_{1}} {a}_{{m}_{2}} {a}_{{m}_{3}} ]}_{{m}_{1} , {m}_{2} , {m}_{3} = 1 , 2 , 3 , 4} d {𝕜}_{{f}_{3}} + … + \frac{1}{{( 2 π )}^{L - 1}} \int {f}_{L} {[ {a}_{{m}_{1}} {a}_{{m}_{2}} {a}_{{m}_{3}} … {a}_{{m}_{L}} ]}_{{m}_{1} , {m}_{2} , {m}_{3} , … , {m}_{L} = 1 , 2 , 3 , 4} d {𝕜}_{{f}_{L}} \qquad [ Math . 6 ]$$
to derive
$${{a}_{{m}_{1}}}_{{m}_{1} = 1 , 2 , 3 , 4} \qquad [ Math . 7 ]$$
from which an effect of multiple scattering has been removed,
where a₁, a₂, a₃, and a₄ expressed by aₘ₁, aₘ₂, aₘ₃, . . . , a_{mL} correspond to a(kₓ, k_{y1}, k_{y2}, k) in the analytical solution related to the four scattering states, f₂, f₃, . . . , f_{L} denote products of 2, 3, . . . , L variables in square brackets corresponding to 2, 3, . . . , L scattering applied from transmission of the wave to reception of the wave, respectively,
$${𝕜}_{{f}_{2}} , {𝕜}_{{f}_{3}} , … , {𝕜}_{{f}_{L}} \qquad [ Math . 8 ]$$
denote wave number vectors related to coordinate variables included in 2, 3, . . . , L variables in square brackets of f₂, f₃, . . . , f_{L}, and the information processing circuit uses, as the scattering field function,
$${ϕ}_{{m}_{1}} ( x , {y}_{1} , {y}_{2} , {z}_{1} , {z}_{2} , k ) = \frac{1}{{( 2 π )}^{3}} {\int }_{- ∞}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{{m}_{1}} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 9 ]$$
$${m}_{1} = 1 , 2 , 3 , 4$$
to derive, as the imaging function,
$$ρ ( x , y , z ) = {Lim}_{t \to 0} [ \frac{1}{2 π} {{\int }^{∞}}_{- ∞} {ϕ}_{{m}_{1}} ( x , y , y , z , z , k ) {e}^{- ickt} dk ] . \qquad [ Math . 10 ]$$

7. The imaging device according to claim 4,
wherein the measurement data is expressed by
$${{Φ}_{ij}}_{i , j = 1 , 2} \qquad [ Math . 11 ]$$
where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions,
the information processing circuit uses
$${{a}_{m}}_{m = 1 , 2 , 3 , 4} = {{Φ}_{ij}}_{ij = 1 , 2} - \frac{1}{{( 2 π )}^{1}} \int {g}_{2} {[ {Φ}_{{m}_{1} {n}_{1}} {Φ}_{{m}_{2} {n}_{2}} ]}_{{{m}_{1} , {n}_{1} = 1 , 2}_{{m}_{2} , {n}_{2} = 1 , 2}} d {𝕜}_{{g}_{2}} - \frac{1}{{( 2 π )}^{2}} \int {g}_{3} {[ {Φ}_{{m}_{1} {n}_{1}} {Φ}_{{m}_{2} {n}_{2}} {Φ}_{{m}_{3} {n}_{3}} ]}_{{{m}_{1} , {n}_{1} = 1 , 2}_{{{m}_{2} , {n}_{2} = 1 , 2}_{{m}_{3} , {n}_{3} = 1 , 2}}} d {𝕜}_{{g}_{3}} - … - \frac{1}{{( 2 π )}^{L - 1}} \int {g}_{L} {[ {Φ}_{{m}_{1} {n}_{1}} {Φ}_{{m}_{2} {n}_{2}} {Φ}_{{m}_{3} {n}_{3}} … {Φ}_{{m}_{L} {n}_{L}} ]}_{{{m}_{1} , {n}_{1} = 1 , 2}_{{{m}_{2} , {n}_{2} = 1 , 2}_{{{m}_{3} , {n}_{3} = 1 , 2}_{{…}_{{m}_{L} , {n}_{L} = 1 , 2}}}}} d {𝕜}_{{g}_{L}} \qquad [ Math . 12 ]$$
to derive
$${{a}_{m}}_{m = 1 , 2 , 3 , 4} \qquad [ Math . 13 ]$$
from which an effect of multiple scattering has been removed,
where a₁, a₂, a₃, and a₄ expressed by aₘ correspond to a(kₓ, k_{y1}, k_{y2}, k) in the analytical solution related to the four scattering states, Φ₁₁, Φ₁₂, Φ₂₁, and Φ₂₂ expressed by Φₘ₁ₙ₁, Φₘ₂ₙ₂, Φₘ₃ₙ₃, . . . , Φ_{mLnL} correspond to the measurement data related to the four scattering states, g₂, g₃, . . . , g_{L} denote products of 2, 3, . . . , L variables in square brackets corresponding to 2, 3, . . . , L scattering applied from transmission of the wave to reception of the wave, respectively,
$${𝕜}_{{g}_{2}} , {𝕜}_{{g}_{3}} , … , {𝕜}_{{g}_{L}} \qquad [ Math . 14 ]$$
denote wave number vectors related to coordinate variables included in 2, 3, . . . , L variables in square brackets of g₂, g₃, . . . , g_{L}, and the information processing circuit uses, as the scattering field function,
$${ϕ}_{m} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{m} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 15 ]$$
$$m = 1 , 2 , 3 , 4$$
to derive, as the imaging function,
$$ρ ( x , y , z ) = {Lim}_{t \to 0} [ \frac{1}{2 π} {\int }_{- ∞}^{∞} {ϕ}_{m} ( x , y , y , z , z , k ) {e}^{- ickt} dk ] . \qquad [ Math . 16 ]$$

8. The imaging device according to claim 4,
wherein the measurement data is expressed by
$${{Φ}_{ij}}_{i , j = 1 , 2} \qquad [ Math . 17 ]$$
where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions,
the information processing circuit uses
$${Φ}_{11} ( {k}_{x} , {k}_{{y}_{1}} , {k}_{{y}_{2}} , k ) = {a}_{1} ( {k}_{x} , {k}_{{y}_{1}} , {k}_{{y}_{2}} , k ) + \frac{1}{( 2 π )} \int \int \int {a}_{1} ( {k}_{{x}_{a}} , {k}_{{y}_{1}} , {k}_{η} , k ) {a}_{4} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{x b} , - {k}_{η} , {k}_{{y}_{2}} ) ) {dk}_{{x}_{a}} {dk}_{{x}_{b}} {dk}_{η} + \frac{1}{{( 2 π )}^{2}} \int \int \int \int \int {a}_{1} ( {k}_{xa} , {k}_{{y}_{1}} , - {k}_{{η}_{2}} , k ) {a}_{2} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{1} ( {k}_{xb} , {k}_{{η}_{2}} , - {k}_{{η}_{3}} , k ) {a}_{4} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{1} ( {k}_{xa} , {k}_{{y}_{1}} , - {k}_{{η}_{2}} , k ) {a}_{4} ( {k}_{xb} , {k}_{{η}_{2}} , - {{k}_{η}}_{3} , k ) {a}_{4} ( {k}_{x c} , {k}_{{η}_{3}} , {k}_{{y}_{2}} , k ) \cdot δ ( {k}_{x a} + {k}_{x b} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{x b} , {k}_{{η}_{2}} , - {k}_{{η}_{3}} ) - {s}_{1} ( {k}_{xc} , {k}_{{η}_{3}} , {{k}_{y}}_{2} ) ) {dk}_{xa} {dk}_{xb} {dk}_{xc} {dk}_{{η}_{2}} {dk}_{{η}_{3}} + \frac{1}{{( 2 π )}^{2}} \int \int \int \int \int {a}_{3} ( {k}_{xa} , {k}_{{y}_{1}} , - {k}_{{η}_{2}} , k ) {a}_{3} ( {k}_{xb} , {k}_{{η}_{2}} , - {k}_{{η}_{3}} , k ) {a}_{1} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} + O ( {a}^{4} ) \qquad [ Math . 18 ]$$
to derive a₁ from which an effect of multiple scattering has been removed,
where δ denotes a delta function, kₓₐ, k_{xb}, and k_{xc} are variables corresponding to kₓ, k_{η}, and k_{η2} are variables corresponding to k_{y1}, k_{η3} is a variable corresponding to k_{y2}, and O(a⁴) is a term corresponding to a fourth or higher order scattering, and
the information processing circuit uses, as the scattering field function,
$${ϕ}_{1} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 19 ]$$
to derive, as the imaging function,
$$ρ ( x , y , z ) = {Lim}_{t \to 0} [ \frac{1}{2 π} {\int }_{- ∞}^{∞} {ϕ}_{1} ( x , y , y , z , z , k ) {e}^{- ickt} dk ] . \qquad [ Math . 20 ]$$

9. The imaging device according to claim 4,
wherein the measurement data is expressed by
$${{Φ}_{ij}}_{i , j = 1 , 2} \qquad [ Math . 21 ]$$
where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions,
the information processing circuit uses
$${a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{( 2 π )} \int \int \int {Φ}_{11} ( {k}_{{x}_{a}} , {k}_{{y}_{1}} , {k}_{η} , k ) {Φ}_{21} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{x b} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{12} ( {k}_{xa} , {k}_{{y}_{1}} , - {k}_{{η}_{2}} , k ) {Φ}_{11} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{11} ( {k}_{xa} , {k}_{{y}_{1}} , - {k}_{{η}_{2}} , k ) {Φ}_{21} ( {k}_{xb} , {k}_{{η}_{2}} , - {{k}_{η}}_{3} , k ) {Φ}_{21} ( {k}_{x c} , {k}_{{η}_{3}} , {k}_{{y}_{2}} , k ) \cdot δ ( {k}_{x a} + {k}_{x b} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{x b} , {k}_{{η}_{2}} , - {k}_{{η}_{3}} ) - {s}_{1} ( {k}_{xc} , {k}_{{η}_{3}} , {{k}_{y}}_{2} ) ) {dk}_{xa} {dk}_{xb} {dk}_{xc} {dk}_{{η}_{2}} {dk}_{{η}_{3}} - \frac{1}{{( 2 π )}^{2}} \int \int \int \int \int {Φ}_{12} ( {k}_{xa} , {k}_{{y}_{1}} , - {k}_{{η}_{2}} , k ) {Φ}_{12} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \cdot δ ( {k}_{xa} + {k}_{xb} + {k}_{xc} - {k}_{x} ) δ ( {s}_{1} ( {k}_{xb} , {k}_{{η}_{2}} , - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} \qquad [ Math . 22 ]$$
to derive a₁ from which an effect of multiple scattering has been removed,
where δ denotes a delta function, kₓₐ, k_{xb}, and k_{xc} are variables corresponding to kₓ, k_{η} and k_{η2} are variables corresponding to k_{y1}, k_{η3} is a variable corresponding to k_{y2}, and
the information processing circuit uses, as the scattering field function,
$${ϕ}_{1} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 23 ]$$
to derive, as the imaging function,
$$ρ ( x , y , z ) = {Lim}_{t \to 0} [ \frac{1}{2 π} {\int }_{- ∞}^{∞} {ϕ}_{1} ( x , y , y , z , z , k ) {e}^{- ickt} dk ] . \qquad [ Math . 24 ]$$

10. The imaging device according to claim 4,
wherein the measurement data is expressed by
$${{Φ}_{ij}}_{i , j = 1 , 2} \qquad [ Math . 25 ]$$
where Φ₁₁, Φ₁₂, Φ₂₁, and Φ₂₂ expressed by Φᵢⱼ correspond to the measurement data related to four scattering states that include two forward scattering corresponding to two directions and two back scattering corresponding to two directions,
the information processing circuit uses
$${a}_{1} ( {k}_{x} , {k}_{{y}_{1}} , {k}_{{y}_{2}} , k ) = {Φ}_{11} ( {k}_{x} , {k}_{{y}_{1}} , {k}_{{y}_{2}} , k ) - \frac{1}{( 2 π )} \int \int \int {Φ}_{11} ( {k}_{{x}_{a}} , {k}_{{y}_{1}} , {k}_{η} , k ) {Φ}_{21} ( {k}_{{x}_{b}} , - {k}_{η} , {k}_{{y}_{2}} , k ) δ ( {k}_{xa} + {k}_{xb} - {k}_{x} ) \cdot δ ( {s}_{2} ( {k}_{xa} , {k}_{{y}_{1}} , {k}_{η} ) - {s}_{1} ( {k}_{x b} , - {k}_{η} , {k}_{{y}_{2}} ) ) {dk}_{{x}_{a}} {dk}_{{x}_{b}} {dk}_{η} - \frac{1}{{( 2 π )}^{2}} \int \int \int \int \int \{ {Φ}_{11} ( {k}_{xa} , {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( \text{} {k}_{xc} , {k}_{{η}_{3}} , {k}_{{y}_{2}} , k ) + {Φ}_{12} ( {k}_{xa} , {k}_{{y}_{1}} , - {k}_{{η}_{2}} , k ) {Φ}_{22} ( \text{} {k}_{xb} , \text{} {k}_{{η}_{2}} , \text{} - {k}_{{η}_{3}} , \text{} k ) {Φ}_{21} ( {k}_{xc} , {k}_{{η}_{3}} , {k}_{{y}_{2}} , k ) + {Φ}_{11} ( {k}_{xa} , \text{} {k}_{{y}_{1}} , \text{} - {k}_{{η}_{2}} , \text{} k ) {Φ}_{22} ( {k}_{xb} , {k}_{{η}_{2}} , - {k}_{{η}_{3}} , k ) {Φ}_{21} ( {k}_{xc} , {k}_{{η}_{3}} , {k}_{{y}_{2}} , k ) + {Φ}_{12} ( {k}_{xa} , \text{} {k}_{{y}_{1}} , - {k}_{{η}_{2}} , k ) {Φ}_{22} ( {k}_{xb} , {k}_{{η}_{2}} , - {k}_{{η}_{3}} , k ) {Φ}_{11} ( {k}_{xc} , {k}_{{η}_{3}} , {k}_{{y}_{2}} , k ) \} \cdot δ ( {k}_{xa} + {k}_{xb} + {k}_{xc} - {k}_{x} ) δ ( {s}_{1} ( {k}_{xb} , {k}_{{η}_{2}} - {k}_{{η}_{3}} ) - {s}_{2} ( {k}_{xa} , {k}_{{y}_{1}} , - {k}_{{η}_{2}} ) ) \cdot δ ( {s}_{2} ( {k}_{xb} , {k}_{{η}_{2}} , - {k}_{{η}_{3}} ) - {s}_{1} ( {k}_{xa} , {k}_{{η}_{3}} , {k}_{{y}_{2}} ) ) {dk}_{xa} {dk}_{xb} {dk}_{xc} {dk}_{{η}_{2}} {dk}_{{η}_{3}} \qquad [ Math . 26 ]$$
to derive a₁ from which an effect of multiple scattering has been removed,
where δ denotes a delta function, kₓₐ, k_{xb}, and k_{xc} are variables corresponding to kₓ, k_{η} and k_{η2} are variables corresponding to k_{y1}, k_{η3} is a variable corresponding to k_{y2}, and
the information processing circuit uses, as the scattering field function,
$${ϕ}_{1} ( x , {y}_{1} , {y}_{2} , {z}_{1} , {z}_{2} , k ) = \frac{1}{{( 2 π )}^{3}} {{\int }_{- ∞}}^{∞} {{\int }_{- ∞}}^{∞} {{\int }_{- ∞}}^{∞} {e}^{- i ( {k}_{x} x + {k}_{{y}_{1}} {y}_{1} + {k}_{{y}_{2}} {y}_{2} )} {a}_{1} ( {k}_{x} , {k}_{{y}_{1}} , {k}_{{y}_{2}} , k ) \cdot {e}^{{is}_{1} ( {k}_{x} , {k}_{{y}_{1}} , {k}_{{y}_{2}} ) {z}_{1}} {e}^{{is}_{2} ( {k}_{x} , {k}_{{y}_{1}} , {k}_{{y}_{2}} ) {z}_{2}} {dk}_{x} {dk}_{{y}_{1}} {dk}_{{y}_{2}} \qquad [ Math . 27 ]$$
to derive, as the imaging function,
$$ρ ( x , y , z ) = {Lim}_{t \to 0} [ \frac{1}{2 π} {\int }_{- ∞}^{∞} {ϕ}_{1} ( x , y , y , z , z , k ) {e}^{- ickt} dk ] . \qquad [ Math . 28 ]$$

11. An imaging method comprising:
transmitting, by each of a plurality of transmitters disposed on both sides of the region, a wave to a region to be measured;
receiving, by each of a plurality of receivers disposed on the both sides, the wave from the region; and
deriving an imaging function corresponding to a scattering field function related to scattering of the wave according to a correspondence between (i) measurement data obtained by the plurality of transmitters and the plurality of receivers and a composition of a plurality of functions related to multiple first-order scattering forming multiple scattering, and visualizing a three-dimensional structure of a scatterer included in an object in the region, using the imaging function.
